(19) United States
(12) Patent Application Publication
(10) Pub. No.: US 2026/0357752 A1
(43) Pub. Date: Nov. 12, 2026

(54) GAS TURBINE STATOR VANE AND GAS TURBINE

(71) Applicant: MITSUBISHI HEAVY INDUSTRIES, LTD., Tokyo (JP)

(72) Inventors: Yasuo MIYAHISA, Tokyo (JP); Saki MATSUO, Tokyo (JP); Shunsuke TORII, Tokyo (JP)

(21) Appl. No.: 19/102,949

(22) PCT Filed: Aug. 7, 2023
(86) PCT No.: PCT/JP2023/028722

§ 371 Date: Feb. 11, 2025

(30) Foreign Application Priority Data
Sep. 1, 2022 (JP) 2022-138919

(51) Int. Cl. F02C 7/18

(52) U.S. Cl. CPC F02C 7/18; F05D 2240/12; F05D 2260/232

(57) ABSTRACT

A gas turbine stator vane in which, when defining a first plane as a plane including the thickness direction of a leading edge portion and the vane height direction at a center of an inlet of a first film cooling hole, a center of an outlet of the first film cooling hole is positioned at a downstream side of a flow of combustion gas with respect to a position where the first plane and an outer surface of the leading edge portion intersect. When defining a second plane as a plane including the thickness direction of the leading edge portion and the vane height direction at a center of an inlet of the second film cooling hole, an outlet of the second film cooling hole is positioned at a position where the second plane and the outer surface of the leading edge portion intersect.

### TECHNICAL FIELD

The present disclosure relates to a gas turbine stator vane and a gas turbine. The present application claims priority based on Japanese Patent Application No. 2022-138919 filed on Sep. 1, 2022 with the Japanese Patent Office, the contents of which are incorporated herein by reference.

### BACKGROUND ART

The leading edge portion of a gas turbine stator vane is exposed to a flow of high temperature combustion gas. Patent Document 1 discloses film cooling of a surface of a gas turbine stator vane (vane surface) that uses cooling air that flows out from a plurality of film cooling holes disposed on a leading edge portion of the gas turbine stator vane, in order to maintain the metal temperature of the gas turbine stator vane at a temperature not higher than the allowance temperature of the material of the vane.

### CITATION LIST

### Patent Literature

Patent Document 1: JPH10-220203A

### SUMMARY

### Technical Problem

The gas turbine stator vane disclosed in Patent Document 1 has room for improvement in terms of the effectiveness of film cooling of the vane surface of the gas turbine stationary vane using a smaller amount of cooling air.

In view of the above, an object of at least one embodiment of the present disclosure is to provide a gas turbine stator vane and a gas turbine having the same which are capable of suppressing deterioration of film efficiency of film cooling of a vane surface while reducing the amount of cooling air.

### Solution to the Problem

(1) According to at least one embodiment of the present disclosure, a gas turbine stator vane includes: an airfoil portion having a cavity formed therein, wherein the airfoil portion includes a leading edge portion which has: a first film cooling hole row formed thereon including a plurality of first film cooling holes arranged along a vane height direction; a second film cooling hole row formed thereon including a plurality of second film cooling holes arranged along the vane height direction; and a third film cooling hole row formed thereon including a plurality of third film cooling holes arranged along the vane height direction. The second film cooling row is disposed between the first film cooling hole row and the third film cooling hole row. Each of the first film cooling holes extends in a direction inclined with respect to a thickness direction of the leading edge portion, and when defining a first plane as a plane including the thickness direction of the leading edge portion and the vane height direction at a center of an inlet of the first film cooling hole, a center of an outlet of the first film cooling hole is positioned at a downstream side of a flow of combustion gas along the leading edge portion with respect to a position where the first plane and an outer surface of the leading edge portion intersect. Each of the second film cooling holes extends in a direction inclined with respect to the thickness direction of the leading edge portion, and when defining a second plane as a plane including the thickness direction of the leading edge portion and the vane height direction at a center of an inlet of the second film cooling hole, an outlet of the second film cooling hole is positioned at a position where the second plane and the outer surface of the leading edge portion intersect. Each of the third film cooling holes extends in a direction inclined with respect to the thickness direction of the leading edge portion, and when defining a third plane as a plane including the thickness direction of the leading edge portion and the vane height direction at a center of an inlet of the third film cooling hole, a center of an outlet of the third film cooling hole is positioned at a downstream side of the flow of the combustion gas along the leading edge portion with respect to a position where the third plane and the outer surface of the leading edge portion intersect.

### Advantageous Effects

According to at least one embodiment of the present disclosure, a gas turbine stator vane and a gas turbine having the same which are capable of suppressing deterioration of film efficiency of film cooling of a vane surface while reducing the amount of cooling air are provided.

### BRIEF DESCRIPTION OF DRAWINGS

FIG. 1 is a schematic configuration diagram of a gas turbine 2 according to an embodiment of the present disclosure.

FIG. 2 is a diagram showing an example of a cross section of a turbine stator vane 12 according to an embodiment of the present disclosure, taken along the vane height direction.

FIG. 3 is a diagram showing an example of a cross section of the turbine stator vane 12 depicted in FIG. 2, taken along a direction that is orthogonal to the vane height direction.

FIG. 4 is an enlarged cross-sectional view of a leading edge portion 21 depicted in FIG. 3.

FIG. 5 is a diagram of an outer surface 25 of the leading edge portion 21 of an airfoil portion 20 seen in a direction orthogonal to the outer surface 25.

FIG. 6 is a diagram showing an example of a cross section of the leading edge portion 21 of the airfoil portion 20, taken along the vane height direction at the position of a first film cooling hole row R71.

FIG. 7A is an enlarged cross-sectional view of an outer first film cooling hole 711 which is a first film cooling hole 71 in the vicinity of an outer shroud 22 in FIG. 6.

FIG. 7B is an enlarged cross-sectional view of an inner first film cooling hole 712 which is a first film cooling hole 71 in the vicinity of an inner shroud 24 in FIG. 6.

FIG. 8A is a cross-sectional view taken along line QG-QG in FIG. 7A.

FIG. 8B is a cross-sectional view taken along line QH-QH in FIG. 7B.

FIG. 9 is a diagram showing an example of a cross section of the leading edge portion 21 of the airfoil portion 20, taken along the vane height direction at the position of a second film cooling hole row R72.

FIG. 10A is an enlarged cross-sectional view of an outer second film cooling hole 721 which is a second film cooling hole 72 in the vicinity of the outer shroud 22 in FIG. 9.

FIG. 10B is an enlarged cross-sectional view of an inner second film cooling hole 722 which is a second film cooling hole 72 in the vicinity of the inner shroud 24 in FIG. 9.

FIG. 11A is a cross-sectional view taken along line QJ-QJ in FIG. 10A.

FIG. 11B is a cross-sectional view taken along line QK-QK in FIG. 10B.

FIG. 12 is a diagram showing an example of a cross section of the leading edge portion 21 of the airfoil portion 20, taken along the vane height direction at the position of a third film cooling hole row R73.

FIG. 13A is an enlarged cross-sectional view of an outer third film cooling hole 731 which is a third film cooling hole 73 in the vicinity of the outer shroud 22 in FIG. 12.

FIG. 13B is an enlarged cross-sectional view of an inner third film cooling hole 732 which is a third film cooling hole 73 in the vicinity of the inner shroud 24 in FIG. 12.

FIG. 14A is a cross-sectional view taken along line QL-QL in FIG. 13A.

FIG. 14B is a cross-sectional view taken along line QM-QM in FIG. 13B.

FIG. 15 is a diagram showing a cross section of an airfoil portion 020 according to a first comparative example, taken along a direction that is orthogonal to the vane height direction.

FIG. 16 is a diagram showing the relationship between the distance from the second film cooling hole row R72 of the turbine stator vane 12 according to an embodiment and the average film efficiency in the vane span direction, and the relationship between the distance from a film cooling hole row 07 that is the third row of a turbine stator vane 012 according to the first comparative example (the film cooling hole row corresponding to the second film cooling hole row R72) and the average film efficiency in the vane span direction.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

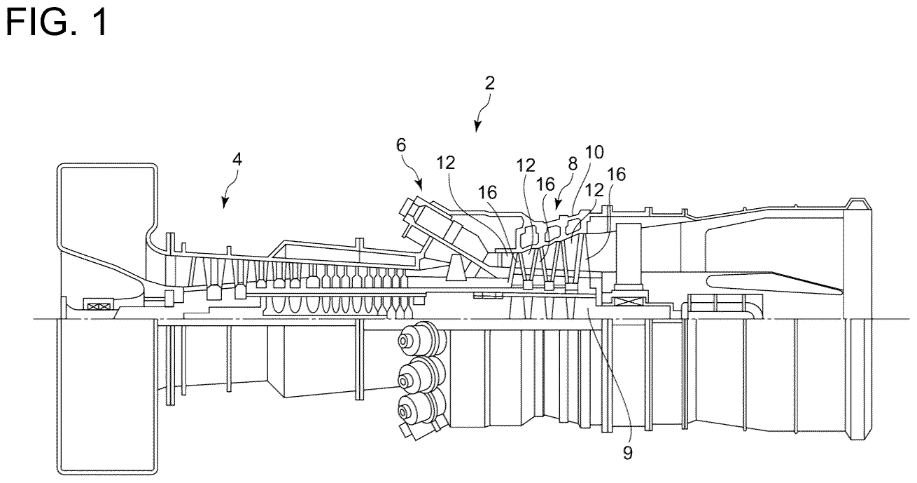

FIG. 1 is a schematic configuration diagram of a gas turbine 2 according to an embodiment.

As depicted in FIG. 1, the gas turbine 2 includes a compressor 4, a combustor 6 for mixing compressed air produced in the compressor 4 with a fuel and combusting the mixture, and a turbine 8 for obtaining power from combustion gas produced by the combustor 6.

As depicted in FIG. 1, the turbine 8 includes a rotor 9 (turbine rotor), a turbine casing 10 that houses the rotor 9, a plurality of turbine stator vanes 12 fixed to an inner surface of the turbine casing 10 (gas turbine stator vane), and a plurality of turbine rotor blades 16 disposed on the rotor 9 so as to be arranged alternately with the turbine stator vanes 12 in the axial direction. Hereinafter, a “circumferential direction” refers to the circumferential direction of the gas turbine 2 that is the circumferential direction of the rotor 9 unless otherwise stated, an “axial direction” refers to the axial direction of the gas turbine 2 that is the axial direction of the rotor 9 unless otherwise stated, and a “radial direction” refers to the radial direction of the gas turbine 2 that is the radial direction of the rotor 9 unless otherwise stated.

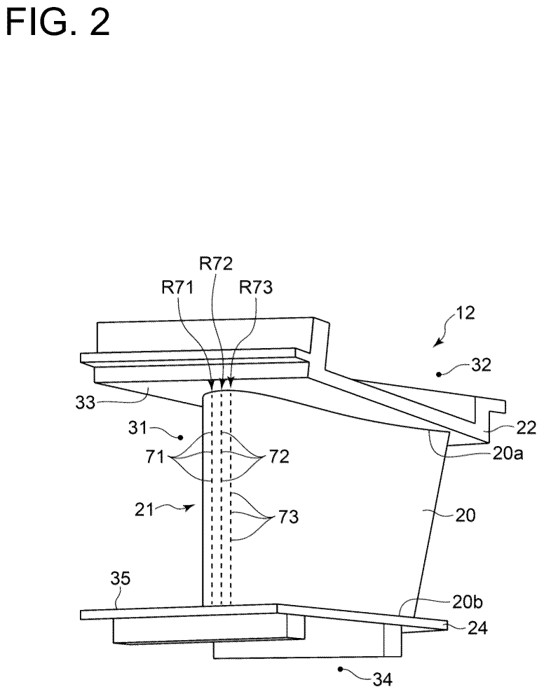

FIG. 2 is a diagram showing an example of a cross section of a turbine stator vane 12 taken along the vane height direction.

The turbine stator vane 12 depicted in FIG. 2 includes an airfoil portion 20, an outer shroud 22, and an inner shroud 24. Hereinafter, a “vane height direction” refers to the vane height direction of the turbine stator vane 12 that is the vane height direction of the airfoil portion 20, and corresponds to the radial direction of the gas turbine 2 that is the radial direction of the rotor 9. Furthermore, an “outer side in the vane height direction” refers to the outer side in the radial direction of the gas turbine 2 that is the outer side in the radial direction of the rotor 9, and an “inner side in the vane height direction” refers to the inner side in the radial direction of the gas turbine 2 that is the inner side in the radial direction of the rotor 9.

The airfoil portion 20 has an airfoil cross-sectional shape that is defined by a pressure surface and a suction surface. An in-vane cavity described below is formed inside the airfoil portion 20. The in-vane cavity brings into communication an outer cavity 32 formed at the outer side of the outer shroud 22 in the vane height direction and an inner cavity 34 formed at the inner side of the inner shroud 24 in the vane height direction. The outer cavity 32 is a space formed between the outer shroud 22 and the turbine casing 10 (see FIG. 1). The inner cavity 34 is a space formed between the inner shroud 24 and an inner-circumferential side diaphragm (not depicted).

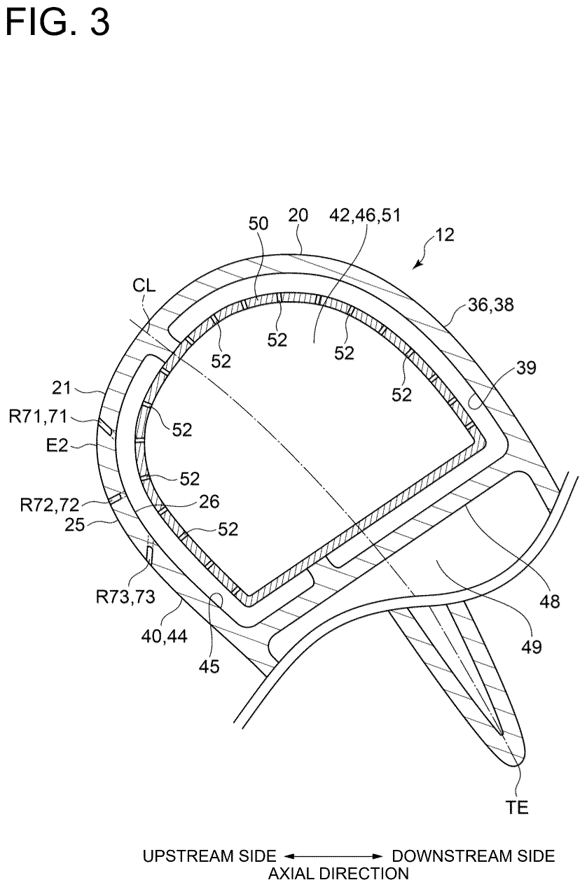

As depicted in FIG. 2, a first film cooling hole row R71, a second film cooling hole row R72, and a third film cooling hole row R73 are formed on the leading edge portion 21 of the airfoil portion 20. In the present specification, a “leading edge portion” refers to a portion of the airfoil portion 20 that includes the most upstream position E2 of the airfoil portion 20 in the axial direction, for instance, a portion disposed opposite to a trailing edge TE of the airfoil portion 20 across a leading edge portion partition wall 48, as depicted in FIG. 3.

The first film cooling hole row R71 includes a plurality of first film cooling holes 71 arranged along the vane height direction. The second film cooling hole row R72 includes a plurality of second film cooling holes 72 arranged along the vane height direction. The third film cooling hole row R73 includes a plurality of third film cooling holes 73 arranged along the vane height direction. The second film cooling hole row R72 is disposed between the first film cooling hole row R71 and the third film cooling hole row R73.

The outer shroud 22 connects to the outer end 20a of the airfoil portion 20 in the vane height direction, and is formed to have a substantially plate shape along a surface that intersects with the vane height direction. The outer shroud 22 forms an outer circumferential wall 33 of a flow passage 31 of combustion gas in the turbine 8 (a main flow passage of combustion gas in the turbine 8). In the present specification, an “upstream side in the axial direction” refers to the upstream side of the main flow of combustion gas (the flow of combustion gas flowing through the flow passage 31) in the turbine 8 in the axial direction, and a “downstream side in the axial direction” refers to the downstream side of the main flow of combustion gas in the turbine 8 in the axial direction.

The inner shroud 24 connects to an inner end 20b of the airfoil portion 20 in the vane height direction, and is formed to have a substantially plate shape along a surface that intersects with the vane height direction. The inner shroud 24 forms an inner circumferential wall 35 of the flow passage 31 of combustion gas in the turbine 8 (a main flow passage of combustion gas in the turbine 8).

FIG. 3 is a diagram showing an example of a cross section of the turbine stator vane 12 depicted in FIG. 2, taken along a direction that is orthogonal to the vane height direction. The turbine stator vane 12 described below may be the turbine stator vane 12 of the first stage to be used under a condition where the temperature is the highest in the turbine 8, for instance.

As depicted in FIG. 3, the airfoil portion 20 of the turbine stator vane 12 includes a suction surface formation wall 38 forming the suction surface 36, and a pressure surface formation wall 44 forming the pressure surface 40 and forming an in-vane cavity 42 between the pressure surface formation wall 44 and the suction surface formation wall 38.

Each of the suction surface formation wall 38 and the pressure surface formation wall 44 may have a curved plate shape having a substantially constant thickness. The in-vane cavity 42 is formed inside the airfoil portion 20 from a first end portion to a second end portion of the airfoil portion 20 along the vane height direction.

In the illustrative embodiment depicted in FIG. 3, a leading edge portion partition wall 48 is disposed in the in-vane cavity 42 of the airfoil portion 20. The leading edge portion partition wall 48 is formed integrally with the airfoil portion 20 by casting, for instance, and configured to extend from an inner surface 39 of the suction surface formation wall 38 to an inner surface 45 of the pressure surface formation wall 44 to divide the in-vane cavity 42 into the leading edge side cavity 46 and the trailing edge side cavity 49. The leading edge portion partition wall 48 may have a plate shape having a substantially constant thickness.

In the illustrative embodiment depicted in FIG. 3, an insert 50 is disposed in the leading edge side cavity 46 of the airfoil portion 20. The insert 50 is formed of sheet metal to have a tube shape, for instance, so as to extend from the first end portion to the second end portion of the airfoil portion 20 along the vane height direction, and inserted into the leading edge side cavity 46. The insert 50 has an internal space 51 which is in communication with the outer cavity 32 (see FIG. 2), and compressed air supplied to the outer cavity 32 from the compressor 4 is supplied as cooling air to the internal space 51 of the insert 50 from the outer cavity 32. The insert 50 has a plurality of impingement cooling hole 52 formed thereon, for impingement cooling of a surface forming the leading edge side cavity 46 of the airfoil portion 20 (the inner surface 39 of the suction surface formation wall 38 and the inner surface 45 of the pressure surface formation wall 44). In the illustrated example, the plurality of impingement cooling holes 52 are formed on a portion of the insert 50 that faces the suction surface formation wall 38 and a portion of the insert 50 that faces the pressure surface formation wall 44.

As depicted in FIG. 3, the first film cooling hole row R71, the second film cooling hole row R72, and the third film cooling hole row R73 are formed on the leading edge portion 21 of the airfoil portion 20. As described above, the first film cooling hole row R71 includes a plurality of first film cooling holes 71 arranged along the vane height direction, the second film cooling hole row R72 includes a plurality of second film cooling holes 72 arranged along the vane height direction, and the third film cooling hole row R73 includes a plurality of third film cooling holes 73 arranged along the vane height direction. Furthermore, the second film cooling hole row R72 is disposed between the first film cooling hole row R71 and the third film cooling hole row R73.

As depicted in FIG. 3, each of the first film cooling holes 71, the second film cooling holes 72, and the third film cooling holes 73 is positioned at the side of the pressure surface 40 with respect to the camber line CL in a cross section of the airfoil portion 20 orthogonal to the vane height direction. That is, each of the first film cooling hole row R71, the second film cooling hole row R72, and the third film cooling hole row R73 is formed on the pressure surface formation wall 44.

The turbine stator vane 12 described above is configured such that at least a part of cooling air supplied to the in-vane cavity 42 of the turbine stator vane 12 from outside the turbine stator vane 12 (e.g. the above described compressor 4) flows out the airfoil portion 20 through at least one of the first film cooling hole 71, the second film cooling hole 72, or the third film cooling hole 73, and flows along the surface of the airfoil portion 20 to perform film cooling on the surface of the airfoil portion 20.

In the illustrative embodiment depicted in FIG. 3, a part of cooling air supplied to the internal space 51 of the insert 50 from outside the turbine stator vane 12 (e.g. the above described compressor 4) blows out from the plurality of impingement cooling holes 52 of the insert 50 to perform impingement cooling on a wall surface of the airfoil portion 20 that forms the leading edge side cavity 46. The cooling air after blowing out from the plurality of impingement cooling holes 52 of the insert 50 and performing impingement cooling on the pressure surface formation wall 44 flows out the leading edge portion 21 through the first film cooling hole 71, the second film cooling hole 72, or the third film cooling hole 73, flows along the surface of the airfoil portion 20, and performs film cooling on the surface of the airfoil portion 20.

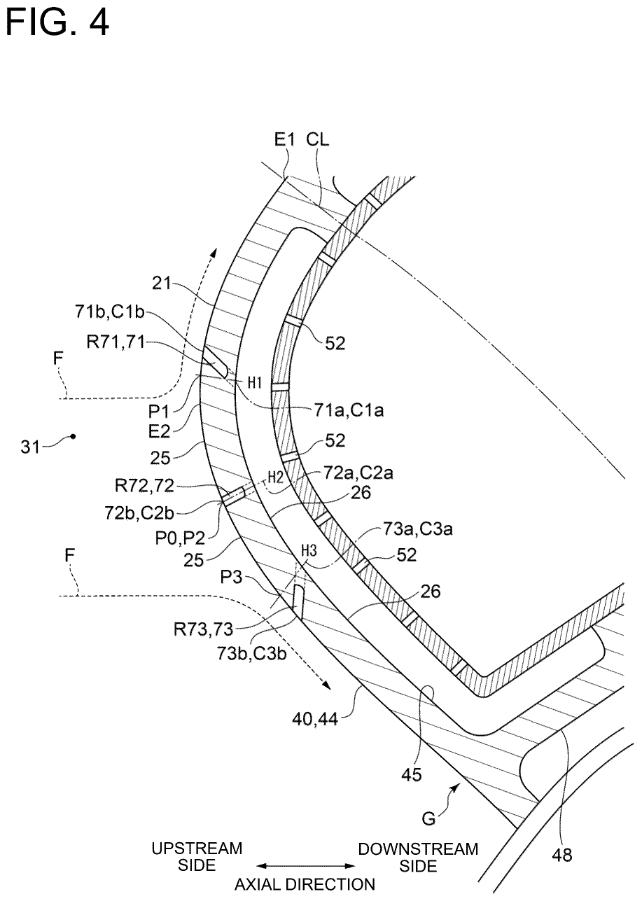

FIG. 4 is an enlarged cross-sectional view of the leading edge portion 21 depicted in FIG. 3.

As depicted in FIG. 4, each of the first film cooling holes 71 is formed as a through hole which penetrates through the leading edge portion 21, and extends from the inlet 71a to the outlet 71b of the first film cooling hole 71 along a direction that is inclined with respect to the thickness direction of the leading edge portion 21 (a direction orthogonal to each of the outer surface 25 and the inner surface 26 of the leading edge portion 21).

In the illustrative embodiment depicted in FIG. 4, each of the first film cooling holes 71 extends from the inlet 71a to the outlet 71b of the first film cooling hole 71 along a direction inclined with respect to a plane orthogonal to the vane height direction (the cross section of the airfoil portion 20 depicted in FIG. 4).

Furthermore, as depicted in FIG. 4, when the first plane H1 is defined as a plane including the thickness direction and the vane height direction of the leading edge portion 21 at the center C1a of the inlet 71a of the first film cooling hole 71, each of the first film cooling holes 71 extends from the inlet 71a to the outlet 71b of the first film cooling hole 71 along a direction inclined with respect to the first plane H1. Furthermore, the center C1b of the outlet 71b of the first film cooling hole 71 is positioned at the downstream side of the flow F of combustion gas along the leading edge portion 21 (a main flow of combustion gas flowing through the flow passage 31) with respect to the position P1 where the first plane H1 intersects with the outer surface 25 of the leading edge portion 21.

As depicted in FIG. 4, each of the second film cooling holes 72 is formed as a through hole which penetrates through the leading edge portion 21, and extends from the inlet 72a to the outlet 72b of the second film cooling hole 72 along a direction that is inclined with respect to the thickness direction of the leading edge portion 21.

In the illustrative embodiment depicted in FIG. 4, each of the second film cooling holes 72 extends from the inlet 72a to the outlet 72b of the second film cooling hole 72 along a direction inclined with respect to a plane orthogonal to the vane height direction.

Furthermore, as depicted in FIG. 4, when the second plane H2 is defined as a plane including the thickness direction and the vane height direction of the leading edge portion 21 at the center C2a of the inlet 72a of the second film cooling hole 72, the outlet 72b of the second film cooling hole 72 is positioned at the position P2 where the second plane H2 intersects with the outer surface 25 of the leading edge portion 21.

As depicted in FIG. 4, each of the third film cooling holes 73 is formed as a through hole which penetrates through the leading edge portion 21, and extends from the inlet 73a to the outlet 73b of the third film cooling hole 73 along a direction that is inclined with respect to the thickness direction of the leading edge portion 21.

In the illustrative embodiment depicted in FIG. 4, each of the third film cooling holes 73 extends from the inlet 73a to the outlet 73b of the third film cooling hole 73 along a direction inclined with respect to a plane orthogonal to the vane height direction.

Furthermore, as depicted in FIG. 4, when the third plane H3 is defined as a plane including the thickness direction and the vane height direction of the leading edge portion 21 at the center C3a of the inlet 73a of the third film cooling hole 73, the center C3b of the outlet 73b of the third film cooling hole 73 is positioned at the downstream side of the flow F of combustion gas along the leading edge portion 21 with respect to the position P3 where the third plane H3 intersects with the outer surface 25 of the leading edge portion 21.

As depicted in FIG. 4, in a cross section of the airfoil portion 20 orthogonal to the vane height direction, when E1 is the intersection between the camber line CL and the outer surface 25 of the leading edge portion 21 and E2 is the most upstream position of the airfoil portion 20 in the axial direction of the gas turbine 2, the center C1b of the outlet 71b of the first film cooling hole 71 is positioned between the intersection E1 and the most upstream position E2 on the outer surface 25 of the airfoil portion 20, the center C2b of the outlet 72b of the second film cooling hole 72 is positioned opposite to the intersection E1 with respect to the most upstream position E2 (the side of the leading edge portion partition wall 48) on the outer surface 25 of the airfoil portion 20, and the center C3b of the outlet 73b of the third film cooling hole 73 is positioned opposite to the intersection E1 with respect to the most upstream position E2 on the outer surface 25 of the airfoil portion 20.

As depicted in FIG. 4, in a cross section of the airfoil portion 20 orthogonal to the vane height direction, each of the first film cooling holes 71, the second film cooling holes 72, and the third film cooling holes 73 is positioned at the upstream side of a position G where the pressure surface formation wall 44 and the leading edge portion partition wall 48 connect in the axial direction.

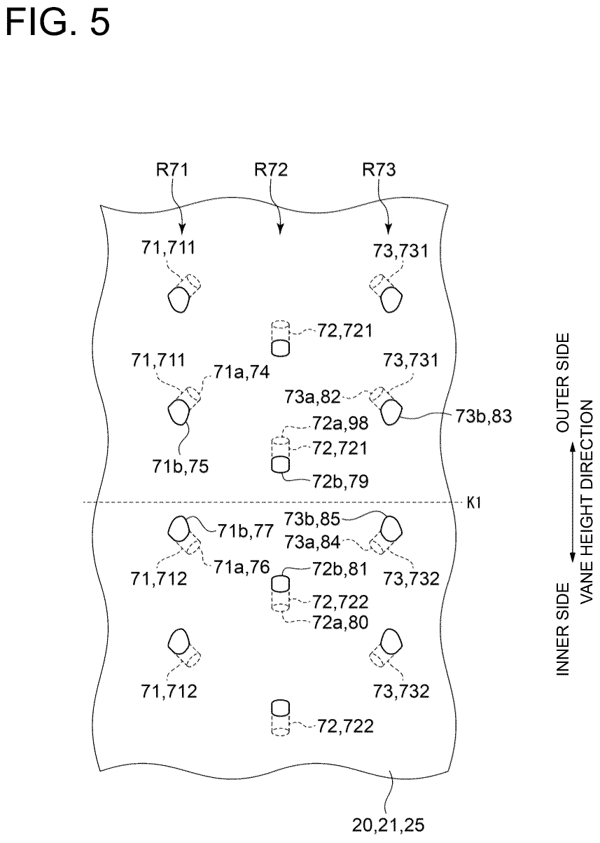

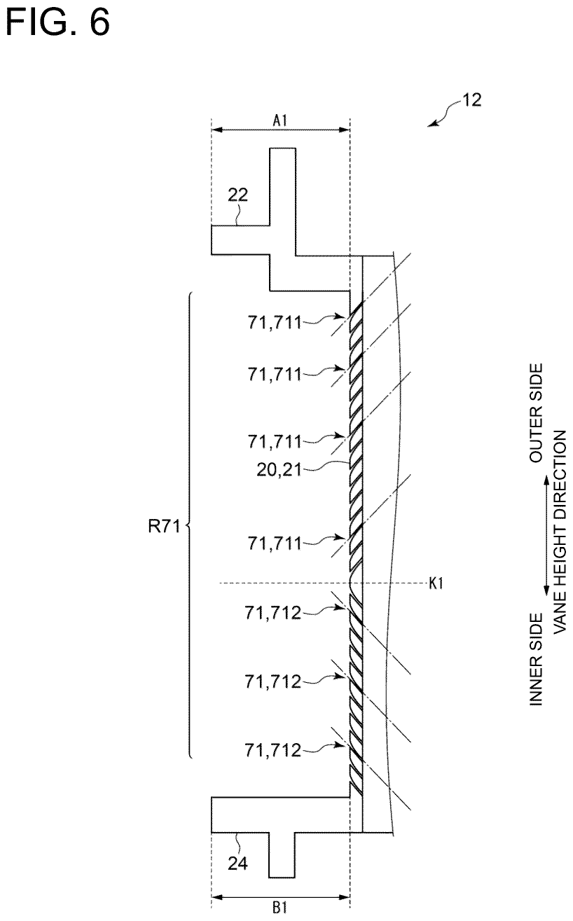

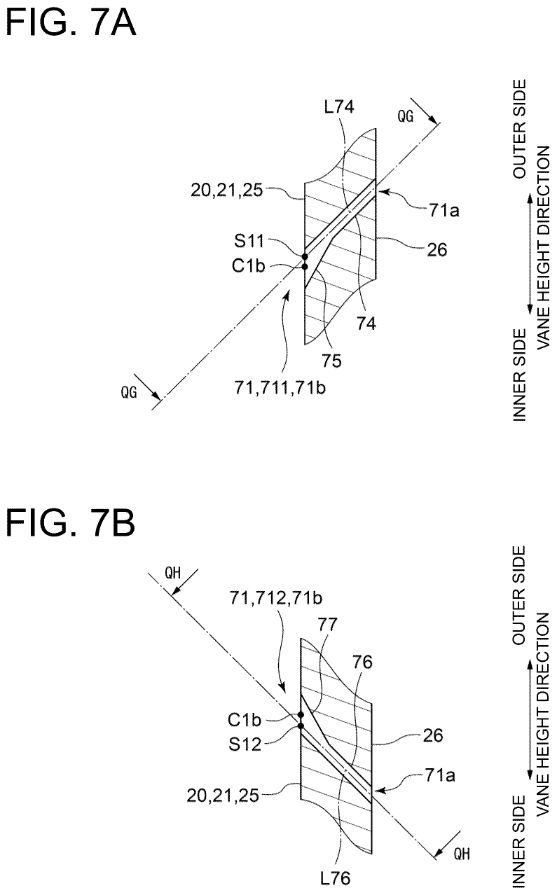

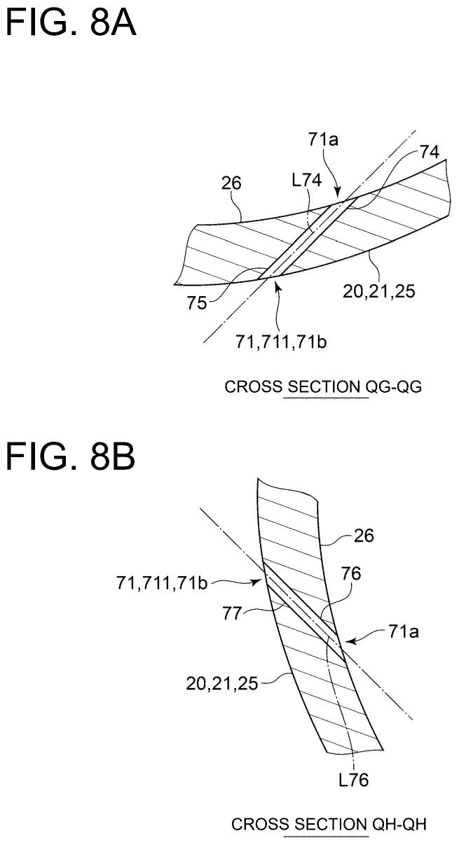

FIG. 5 is a diagram of an outer surface 25 of the leading edge portion 21 of an airfoil portion 20 seen in a direction orthogonal to the outer surface 25. FIG. 6 is a diagram showing an example of a cross section of the leading edge portion 21 of the airfoil portion 20, taken along the vane height direction at the position of the first film cooling hole row R71. FIG. 7A is an enlarged cross-sectional view of an outer first film cooling hole 711 which is a first film cooling hole 71 in the vicinity of the outer shroud 22 in FIG. 6. FIG. 7B is an enlarged cross-sectional view of an inner first film cooling hole 712 which is a first film cooling hole 71 in the vicinity of the inner shroud 24 in FIG. 6. FIG. 8A is a cross-sectional view taken along line QG-QG in FIG. 7A. FIG. 8B is a cross-sectional view taken along line QH-QH in FIG. 7B.

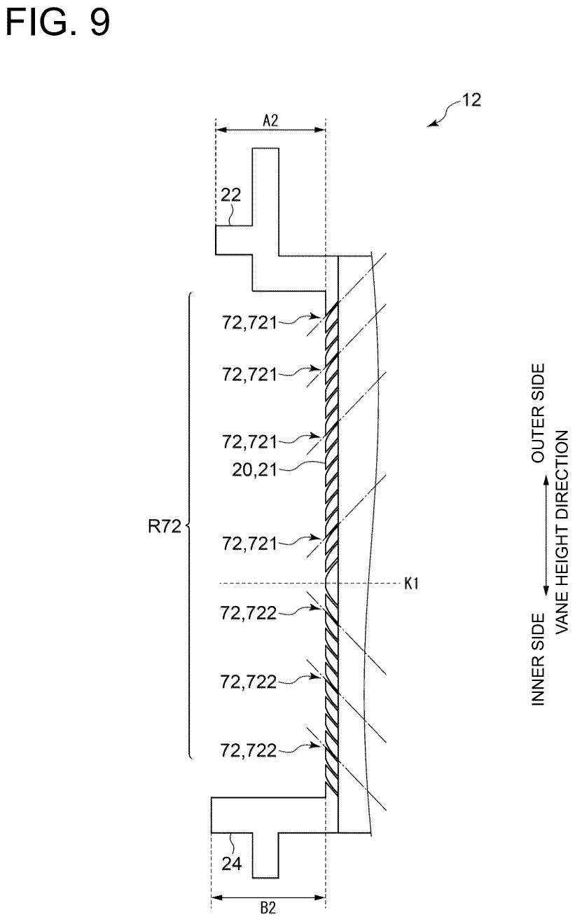

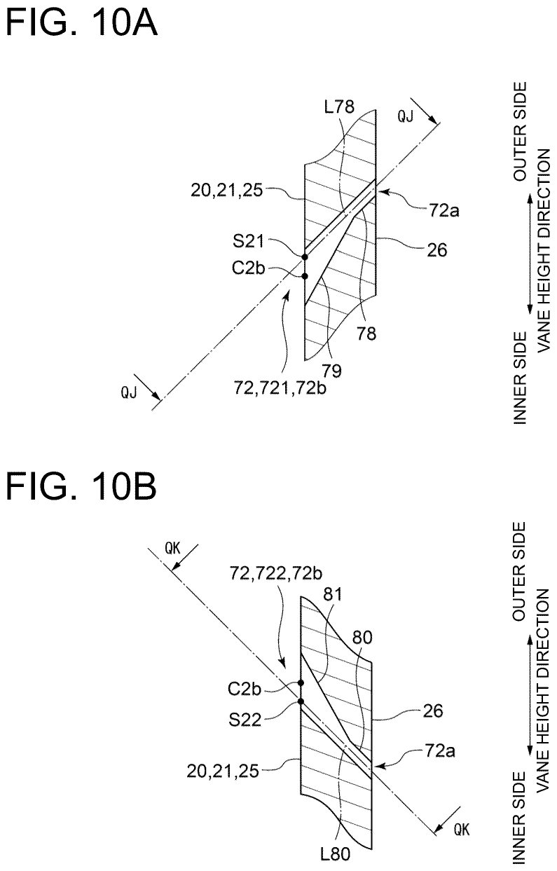

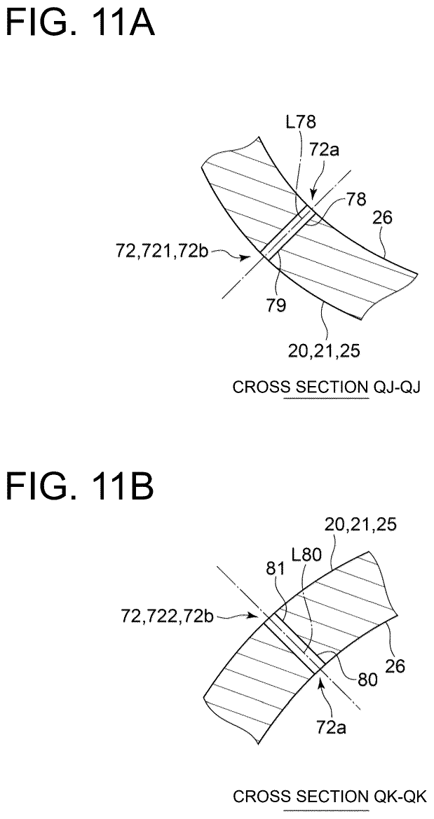

FIG. 9 is a diagram showing an example of a cross section of the leading edge portion 21 of the airfoil portion 20, taken along the vane height direction at the position of the second film cooling hole row R72. FIG. 10A is an enlarged cross-sectional view of an outer second film cooling hole 721 which is a second film cooling hole 72 in the vicinity of the outer shroud 22 in FIG. 9. FIG. 10B is an enlarged cross-sectional view of an inner second film cooling hole 722 which is a second film cooling hole 72 in the vicinity of the inner shroud 24 in FIG. 9. FIG. 11A is a cross-sectional view taken along line QJ-QJ in FIG. 10A. FIG. 11B is a cross-sectional view taken along line QK-QK in FIG. 10B.

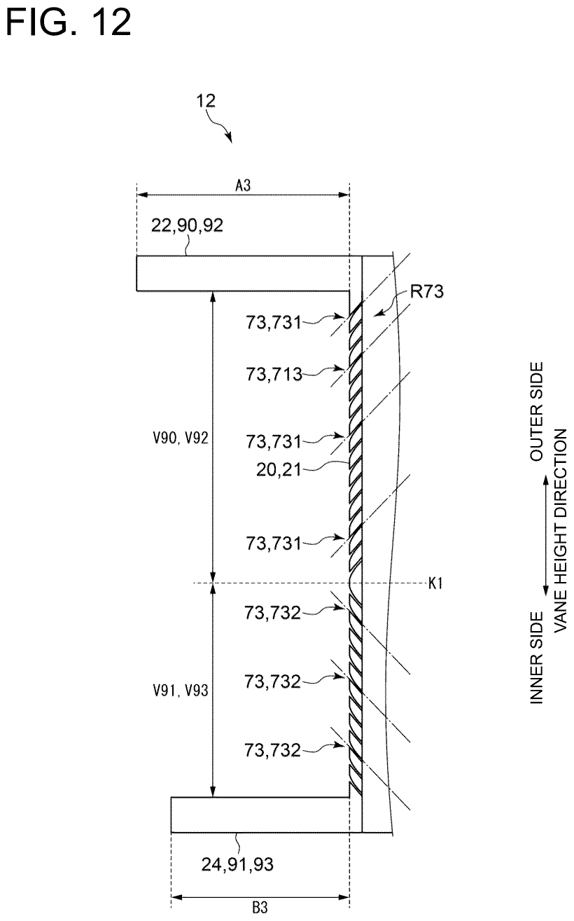

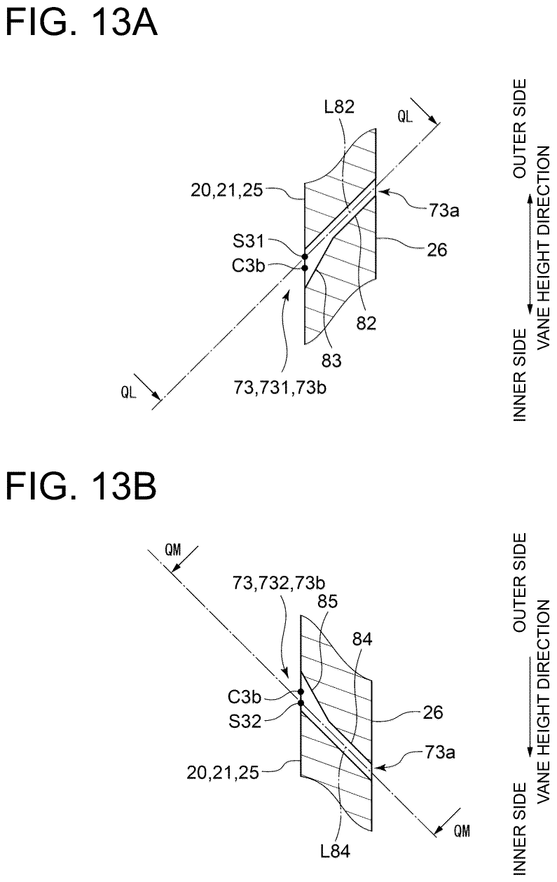

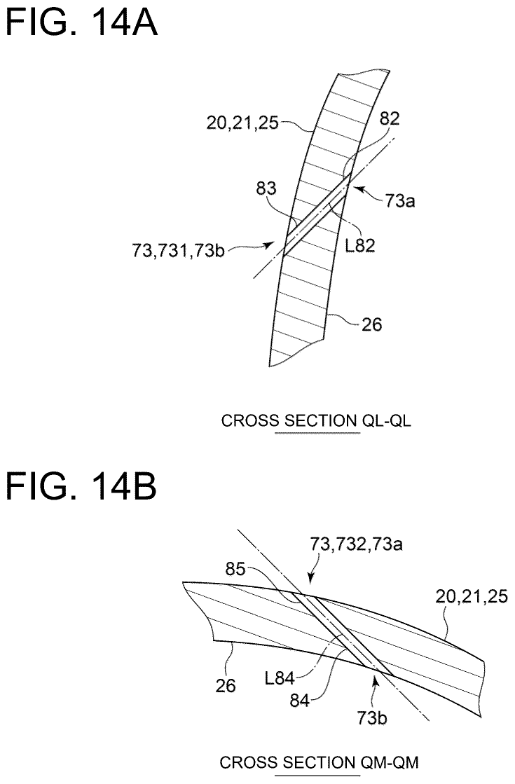

FIG. 12 is a diagram showing an example of a cross section of the leading edge portion 21 of the airfoil portion 20, taken along the vane height direction at the position of a third film cooling hole row R73. FIG. 13A is an enlarged cross-sectional view of an outer third film cooling hole 731 which is a third film cooling hole 73 in the vicinity of the outer shroud 22 in FIG. 12. FIG. 13B is an enlarged cross-sectional view of an inner third film cooling hole 732 which is a third film cooling hole 73 in the vicinity of the inner shroud 24 in FIG. 12. FIG. 14A is a cross-sectional view taken along line QL-QL in FIG. 13A. FIG. 14B is a cross-sectional view taken along line QM-QM in FIG. 13B.

For instance, as depicted in FIGS. 5 and 6, a plurality of first film cooling holes 71 that belong to the first film cooling hole row R71 include a plurality of outer first film cooling holes 711 positioned at the outer side of the first position K1 in the vane height direction and a plurality of inner first film cooling holes 712 positioned at the inner side of the first position K1 in the vane height direction. In the illustrated example, the first position K1 is a position closer to the inner shroud 24 than the center of the airfoil portion 20 in the vane height direction.

For instance, as illustrated in FIG. 7A, the outer first film cooling hole 711 extends inward in the vane height direction from the inlet 71a of the outer first film cooling hole 711 toward the outlet 71b of the outer first film cooling hole 711.

For instance, as illustrated in FIG. 7B, the inner first film cooling hole 712 extends outward in the vane height direction from the inlet 71a of the inner first film cooling hole 712 toward the outlet 71b of the inner first film cooling hole 712.

For instance, as depicted in FIGS. 5 and 9, a plurality of second film cooling holes 72 that belong to the second film cooling hole row R72 include a plurality of outer second film cooling holes 721 positioned at the outer side of the first position K1 in the vane height direction and a plurality of inner second film cooling holes 722 positioned at the inner side of the first position K1 in the vane height direction.

For instance, as illustrated in FIG. 10A, the outer second film cooling hole 721 extends inward in the vane height direction from the inlet 72a of the outer second film cooling hole 721 toward the outlet 72b of the outer second film cooling hole 721.

For instance, as illustrated in FIG. 10B, the inner second film cooling hole 722 extends outward in the vane height direction from the inlet 72a of the inner second film cooling hole 722 toward the outlet 72b of the inner second film cooling hole 722.

For instance, as depicted in FIGS. 5 and 12, a plurality of third film cooling holes 73 that belong to the third film cooling hole row R73 include a plurality of outer third film cooling holes 731 positioned at the outer side of the first position K1 in the vane height direction and a plurality of inner third film cooling holes 732 positioned at the inner side of the first position K1 in the vane height direction.

For instance, as illustrated in FIG. 13A, the outer third film cooling hole 731 extends inward in the vane height direction from the inlet 73a of the outer third film cooling hole 731 toward the outlet 73b of the outer third film cooling hole 731.

For instance, as illustrated in FIG. 13B, the inner third film cooling hole 732 extends outward in the vane height direction from the inlet 73a of the inner third film cooling hole 732 toward the outlet 73b of the inner third film cooling hole 732.

For instance, as depicted in FIGS. 7A and 8A, the outer first film cooling hole 711 includes a circular hole portion 74 and a shaped hole portion 75. The circular hole portion 74 is a portion of the outer first film cooling hole 711 disposed at the side of the inlet 71a, and has a circular cross-sectional shape. The cross-sectional area of the circular hole portion 74 is constant regardless of the position in the direction of the axis L74 of the circular hole portion 74. The shaped hole portion 75 is a portion of the outer first film cooling hole 711 disposed at the side of the outlet 71b, and connects to the circular hole portion 74. The cross-sectional area of the shaped hole portion 75 increases toward the outlet 71b of the outer first film cooling hole 711 (outlet of the shaped hole portion 75). The cross-sectional area of the shaped hole portion 75 is increased only at the inner side with respect to the circular hole portion 74 in the vane height direction in a view seen in the direction of the axis L74 of the circular hole portion 74, and not increased at the outer side with respect to the circular hole portion 74 in the vane height direction. Furthermore, the cross-sectional area of the shaped hole portion 75 is not increased in a direction orthogonal to the vane height direction in a view seen in the direction of the axis L74 of the circular hole portion 74.

As depicted in FIG. 7A, the center C1b of the outlet 71b of the outer first film cooling hole 711 is positioned at the inner side in the vane height direction with respect to the extension line of the axis L74 of the circular hole portion 74 of the outer first film cooling hole 711. More specifically, the center C1b of the outlet 71b of the outer first film cooling hole 711 is positioned at the inner side in the vane height direction with respect to the intersection S11 between the extension line of the axis L74 of the circular hole portion 74 of the outer first film cooling hole 711 and the outlet 71b of the outer first film cooling hole 711.

For instance, as depicted in FIGS. 7B and 8B, the inner first film cooling hole 712 includes a circular hole portion 76 and a shaped hole portion 77. The circular hole portion 76 is a portion of the inner first film cooling hole 712 disposed at the side of the inlet 71a, and has a circular cross-sectional shape. The cross-sectional area of the circular hole portion 76 is constant regardless of the position in the direction of the axis L76 of the circular hole portion 76. The shaped hole portion 77 is a portion of the inner first film cooling hole 712 disposed at the side of the outlet 71b, and connects to the circular hole portion 76. The cross-sectional area of the shaped hole portion 77 increases toward the outlet 71b of the inner first film cooling hole 712 (outlet of the shaped hole portion 77). The cross-sectional area of the shaped hole portion 77 is increased only at the outer side with respect to the circular hole portion 76 in the vane height direction in a view seen in the direction of the axis L76 of the circular hole portion 76, and the cross-sectional area of the shaped hole portion 77 is not increased at the inner side with respect to the circular hole portion 76 in the vane height direction. Furthermore, the cross-sectional area of the shaped hole portion 77 is not increased in a direction orthogonal to the vane height direction in a view seen in the direction of the axis L76 of the circular hole portion 76.

As depicted in FIG. 7B for instance, the center C1b of the outlet 71b of the inner first film cooling hole 712 is positioned at the outer side in the vane height direction with respect to the extension line of the axis L76 of the circular hole portion 76 of the inner first film cooling hole 712. More specifically, the center C1b of the outlet 71b of the inner first film cooling hole 712 is positioned at the outer side in the vane height direction with respect to the intersection S12 between the extension line of the axis L76 of the circular hole portion 76 of the inner first film cooling hole 712 and the outlet 71b of the inner first film cooling hole 712.

For instance, as depicted in FIGS. 10A and 11A, the outer second film cooling hole 721 includes a circular hole portion 78 and a shaped hole portion 79. The circular hole portion 78 is a portion of the outer second film cooling hole 721 disposed at the side of the inlet 72a, and has a circular cross-sectional shape. The cross-sectional area of the circular hole portion 78 is constant regardless of the position in the direction of the axis L78 of the circular hole portion 78. The shaped hole portion 79 is a portion of the outer second film cooling hole 721 disposed at the side of the outlet 72b, and connects to the circular hole portion 78. The cross-sectional area of the shaped hole portion 79 increases toward the outlet 72b of the outer second film cooling hole 721 (outlet of the shaped hole portion 79). The cross-sectional area of the shaped hole portion 79 is increased only at the inner side with respect to the circular hole portion 78 in the vane height direction in a view seen in the direction of the axis L78 of the circular hole portion 78, and not increased at the outer side with respect to the circular hole portion 78 in the vane height direction. Furthermore, the cross-sectional area of the shaped hole portion 79 is not increased with respect to the circular hole portion 78 in a direction orthogonal to the vane height direction in a view seen in the direction of the axis L78 of the circular hole portion 78.

As depicted in FIG. 10A, the center C2b of the outlet 72b of the outer second film cooling hole 721 is positioned at the inner side in the vane height direction with respect to the extension line of the axis L78 of the circular hole portion 78 of the outer second film cooling hole 721. More specifically, the center C2b of the outlet 72b of the outer second film cooling hole 721 is positioned at the inner side in the vane height direction with respect to the intersection S21 between the extension line of the axis L78 of the circular hole portion 78 of the outer second film cooling hole 721 and the outlet 72b of the outer second film cooling hole 721.

For instance, as depicted in FIGS. 5, 10B and 11B, the inner second film cooling hole 722 includes a circular hole portion 80 and a shaped hole portion 81. The circular hole portion 80 is a portion of the inner second film cooling hole 722 disposed at the side of the inlet 72a, and has a circular cross-sectional shape. The cross-sectional area of the circular hole portion 80 is constant regardless of the position in the direction of the axis L80 of the circular hole portion 80. The shaped hole portion 81 is a portion of the inner second film cooling hole 722 disposed at the side of the outlet 72b, and connects to the circular hole portion 80. The cross-sectional area of the shaped hole portion 81 increases toward the outlet 72b of the inner second film cooling hole 722 (outlet of the shaped hole portion 81). The cross-sectional area of the shaped hole portion 81 is increased only at the outer side with respect to the circular hole portion 80 in the vane height direction in a view seen in the direction of the axis L80 of the circular hole portion 80, and not increased at the inner side with respect to the circular hole portion 80 in the vane height direction. Furthermore, the cross-sectional area of the shaped hole portion 81 is not increased with respect to the circular hole portion 80 in a direction orthogonal to the vane height direction in a view seen in the direction of the axis L80 of the circular hole portion 80.

As depicted in FIG. 10B for instance, the center C2b of the outlet 72b of the inner second film cooling hole 722 is positioned at the outer side in the vane height direction with respect to the extension line of the axis L80 of the circular hole portion 80 of the inner second film cooling hole 722. More specifically, the center C2b of the outlet 72b of the inner second film cooling hole 722 is positioned at the outer side in the vane height direction with respect to the intersection S22 between the extension line of the axis L80 of the circular hole portion 80 of the inner second film cooling hole 722 and the outlet 72b of the inner second film cooling hole 722.

For instance, as depicted in FIGS. 13A and 14A, the outer third film cooling hole 731 includes a circular hole portion 82 and a shaped hole portion 83. The circular hole portion 82 is a portion of the outer third film cooling hole 731 disposed at the side of the inlet 73a, and has a circular cross-sectional shape. The cross-sectional area of the circular hole portion 82 is constant regardless of the position in the direction in the axis L82 of the circular hole portion 82. The shaped hole portion 83 is a portion of the outer third film cooling hole 731 disposed at the side of the outlet 73b, and connects to the circular hole portion 82. The cross-sectional area of the shaped hole portion 83 increases toward the outlet 73b of the outer third film cooling hole 731 (outlet of the shaped hole portion 83). The cross-sectional area of the shaped hole portion 83 is increased only at the inner side with respect to the circular hole portion 82 in the vane height direction in a view seen in the direction of the axis L82 of the circular hole portion 82, and the cross-sectional area of the shaped hole portion 83 is not increased at the outer side with respect to the circular hole portion 82 in the vane height direction. Furthermore, the cross-sectional area of the shaped hole portion 83 is not increased with respect to the circular hole portion 82 in a direction orthogonal to the vane height direction in a view seen in the direction of the axis L82 of the circular hole portion 82.

As depicted in FIG. 13A, the center C3b of the outlet 73b of the outer third film cooling hole 731 is positioned at the inner side in the vane height direction with respect to the extension line of the axis L82 of the circular hole portion 82 of the outer third film cooling hole 731. More specifically, the center C3b of the outlet 73b of the outer third film cooling hole 731 is positioned at the inner side in the vane height direction with respect to the intersection S31 between the extension line of the axis L82 of the circular hole portion 82 of the outer third film cooling hole 731 and the outlet 73b of the outer third film cooling hole 731.

For instance, as depicted in FIGS. 5, 13B and 14B, the inner third film cooling hole 732 includes a circular hole portion 84 and a shaped hole portion 85. The circular hole portion 84 is a portion of the inner third film cooling hole 732 disposed at the side of the inlet 73a, and has a circular cross-sectional shape. The cross-sectional area of the circular hole portion 84 is constant regardless of the position in the direction of the axis L84 of the circular hole portion 84. The shaped hole portion 85 is a portion of the inner third film cooling hole 732 disposed at the side of the outlet 73b, and connects to the circular hole portion 84. The cross-sectional area of the shaped hole portion 85 increases toward the outlet 73b of the inner third film cooling hole 732 (outlet of the shaped hole portion 83). The cross-sectional area of the shaped hole portion 85 is increased only at the outer side with respect to the circular hole portion 84 in the vane height direction in a view seen in the direction of the axis L84 of the circular hole portion 84, and the cross-sectional area of the shaped hole portion 85 is not increased at the inner side with respect to the circular hole portion 84 in the vane height direction. Furthermore, the cross-sectional area of the shaped hole portion 85 is not increased with respect to the circular hole portion 84 in a direction orthogonal to the vane height direction in a view seen in the direction of the axis L84 of the circular hole portion 84.

As depicted in FIG. 13B for instance, the center C3b of the outlet 73b of the inner third film cooling hole 732 is positioned at the outer side in the vane height direction with respect to the extension line of the axis L84 of the circular hole portion 84 of the inner third film cooling hole 732. More specifically, the center C3b of the outlet 73b of the inner third film cooling hole 732 is positioned at the outer side in the vane height direction with respect to the intersection S32 between the extension line of the axis L84 of the circular hole portion 84 of the inner third film cooling hole 732 and the outlet 73b of the inner third film cooling hole 732.

As depicted in FIG. 12 for instance, in a cross section including the axis of the third film cooling hole 73 (the axis L82 of the circular hole portion 82 of the outer third film cooling hole 731 in FIG. 13, the axis L84 of the circular hole portion 84 of the inner third film cooling hole 732 in FIG. 13B, and the extension lines of the axis L82 and the axis L84) and the vane height direction, when defining a larger shroud 90 as one of the outer shroud 22 or the inner shroud 24 that has a larger protruding amount from the leading edge portion 21 in a direction orthogonal to the vane height direction and a smaller shroud 91 as one of the outer shroud 22 or the inner shroud 24 that is not the larger shroud 90, the distance V90 between the first position K1 and the larger shroud 90 in the vane height direction is greater than the distance V91 between the first position K1 and the smaller shroud 91 in the vane height direction. In the example depicted in FIG. 12, in a cross-section including the axis of the third film cooling hole 73 and the vane height direction, when defining A3 as the protruding amount of the outer shroud 22 from the leading edge portion 21 in a direction orthogonal to the vane height direction and B3 as the protruding amount of the inner shroud 24 from the leading edge portion 21 in a direction orthogonal to the vane height direction, A3>B3 is satisfied, and thus the outer shroud 22 is the larger shroud 90 and the inner shroud 24 is the smaller shroud 91.

As depicted in FIG. 6 for instance, in a cross section including the axis of the first film cooling hole 71 (the axis L74 of the circular hole portion 74 of the outer first film cooling hole 711 in FIG. 7A, the axis L76 of the circular hole portion 76 of the inner first film cooling hole 712 in FIG. 7B, and the extension lines of the axis L74 and the axis L76) and the vane height direction, A1 is the protruding amount of the outer shroud 22 from the leading edge portion 21 in a direction orthogonal to the vane height direction and B1 is the protruding amount of the inner shroud 24 from the leading edge portion 21 in a direction orthogonal to the vane height direction. Furthermore, as depicted in FIG. 9 for instance, in a cross section including the axis of the second film cooling hole 72 (the axis L78 of the circular hole portion 78 of the outer second film cooling hole 721 in FIG. 10A, the axis L80 of the circular hole portion 80 of the inner second film cooling hole 722 in FIG. 10B, and the extension lines of the axis L78 and the axis L80) and the vane height direction, A2 is the protruding amount of the outer shroud 22 from the leading edge portion 21 in a direction orthogonal to the vane height direction and B2 is the protruding amount of the inner shroud 24 from the leading edge portion 21 in a direction orthogonal to the vane height direction. Furthermore, as depicted in FIG. 12 for instance, in a cross section including the axis of the third film cooling hole 73 (the axis L82 of the circular hole portion 82 of the outer third film cooling hole 731 in FIG. 13A, the axis L84 of the circular hole portion 84 of the inner third film cooling hole 732 in FIG. 13B, and the extension lines of the axis L82 and the axis L84) along the vane height direction, A3 is the protruding amount of the outer shroud 22 from the leading edge portion 21 in a direction orthogonal to the vane height direction and B3 is the protruding amount of the inner shroud 24 from the leading edge portion 21 in a direction orthogonal to the vane height direction.

When defining a larger shroud 92 as one of the outer shroud 22 or the inner shroud 24 that has the largest protruding amount of the protruding amounts A1, A2, A3, B1, B2, and B3 and a smaller shroud 93 as one of the outer shroud 22 or the inner shroud 24 that is not the larger shroud 92, the distance V92 between the first position K1 and the larger shroud 92 in the vane height direction is greater than the distance V93 between the first position K1 and the smaller shroud 93 in the vane height direction. In the example depicted in FIGS. 6, 9, and 12, the largest protruding amount among the protruding amounts A1, A2, A3, B1, B2, and B3 is A3, and thus the outer shroud 22 is the larger shroud 92, and the inner shroud 24 is the smaller shroud 93.

Hereinafter, the advantageous effect of the turbine stator vane 12 will be described. For instance, as depicted in FIG. 4, each of the first film cooling holes 71, the second film cooling holes 72, and the third film cooling hole s73 extends in a direction inclined with respect to the thickness direction of the leading edge portion 21, the center C1b of the outlet 71b of the first film cooling hole 71 is positioned at the downstream side of the flow F of combustion gas along the leading edge portion 21 with respect to the position P1 where the first plane H1 and the outer surface 25 of the leading edge portion 21 intersect, the outlet 72b of the second film cooling hole 72 is positioned at the position P2 where the second plane H2 and the outer surface 25 of the leading edge portion 21 intersect, and the center C3b of the outlet 73b of the third film cooling hole 73 is positioned at the downstream side of the flow F of combustion gas along the leading edge portion 21 with respect to the position P3 where the third plane H3 and the outer surface 25 of the leading edge portion 21 intersect.

Thus, by arranging the second film cooling hole row R72 such that the second film cooling hole 72 is positioned at the position P0 (see FIG. 4) of the stagnation point of the flow of combustion gas on the outer surface 25 of the leading edge portion 21 or in the vicinity thereof, it is possible to let cooling air for film cooling flow out from the first film cooling hole 71 and the third film cooling hole 73 toward the downstream side of the flow of combustion gas, along the outer surface 25 of the leading edge portion 21, at both sides of a boundary which is the position P0 of the stagnation point of the flow of combustion gas on the outer surface 25 of the leading edge portion 21. Therefore, it is possible to perform film cooling on the outer surface 25 of the leading edge portion 21 with a smaller amount of cooling air effectively, and thus it is possible to suppress deterioration of the film efficiency of film cooling of the vane surface while reducing the amount of cooling air.

Furthermore, as depicted in FIGS. 5, 6, and 7A, the outer first film cooling hole 711 positioned at the side of the outer shroud 22 in the vane height direction extends inward in the vane height direction from the inlet 71a toward the outlet 71b of the outer first film cooling hole 711, and thus compared to a case where the outer first film cooling hole 711 extends outward in the vane height direction from the inlet 71a toward the outlet 71b of the outer first film cooling hole 711, it is possible to suppress interference between a jig and the outer shroud 22 when a jig is used to form the outer first film cooling hole 711 by laser processing or the like from the side of the outer surface 25 of the airfoil portion 20.

Furthermore, as depicted in FIGS. 5, 6, and 7B, the inner first film cooling hole 712 positioned at the side of the inner shroud 24 in the vane height direction extends outward in the vane height direction from the inlet 71a toward the outlet 71b of the inner first film cooling hole 712, and thus compared to a case where the inner first film cooling hole 712 extends inward in the vane height direction from the inlet 71a toward the outlet 71b of the inner first film cooling hole 712, it is possible to suppress interference between a jig and the inner shroud 24 when a jig is used to form the inner first film cooling hole 712 from the side of the outer surface 25 of the airfoil portion 20.

Furthermore, as depicted in FIGS. 5, 9, and 10A, the outer second film cooling hole 721 positioned at the side of the outer shroud 22 in the vane height direction extends inward in the vane height direction from the inlet 72a toward the outlet 72b of the outer second film cooling hole 721, and thus compared to a case where the outer second film cooling hole 721 extends outward in the vane height direction from the inlet 71a toward the outlet 72b of the outer second film cooling hole 721, it is possible to suppress interference between a jig and the outer shroud 22 when a jig is used to form the outer second film cooling hole 721 by laser processing or the like from the side of the outer surface 25 of the airfoil portion 20.

Furthermore, as depicted in FIGS. 5, 9, and 10B, the inner second film cooling hole 722 positioned at the side of the inner shroud 24 in the vane height direction extends outward in the vane height direction from the inlet 72a toward the outlet 72b of the inner second film cooling hole 722, and thus compared to a case where the inner second film cooling hole 722 extends inward in the vane height direction from the inlet 72a toward the outlet 72b of the inner second film cooling hole 722, it is possible to suppress interference between a jig and the inner shroud 24 when a jig is used to form the inner second film cooling hole 722 from the side of the outer surface 25 of the airfoil portion 20.

Furthermore, as depicted in FIGS. 5, 12, and 13A, the outer third film cooling hole 731 positioned at the side of the outer shroud 22 in the vane height direction extends inward in the vane height direction from the inlet 73a toward the outlet 73b of the outer third film cooling hole 731, and thus compared to a case where the outer third film cooling hole 731 extends outward in the vane height direction from the inlet 73a toward the outlet 73b of the outer third film cooling hole 731, it is possible to suppress interference between a jig and the outer shroud 22 when a jig is used to form the outer third film cooling hole 731 by laser processing or the like from the side of the outer surface 25 of the airfoil portion 20.

Furthermore, as depicted in FIGS. 5, 12, and 13B, the inner third film cooling hole 732 positioned at the side of the inner shroud 24 in the vane height direction extends outward in the vane height direction from the inlet 73a toward the outlet 73b of the inner third film cooling hole 732, and thus compared to a case where the inner third film cooling hole 732 extends inward in the vane height direction from the inlet 73a toward the outlet 73b of the inner third film cooling hole 732, it is possible to suppress interference between a jig and the inner shroud 24 when a jig is used to form the inner third film cooling hole 732 from the side of the outer surface 25 of the airfoil portion 20.

Furthermore, with respect to the configuration depicted in FIG. 12, when forming each of the outer third film cooling hole 731 and the inner third film cooling hole 732 by laser processing or the like using a jig from the outer surface 25 of the airfoil portion 20, the outer shroud 22 that has a greater protruding amount from the leading edge portion 21 in a direction orthogonal to the vane height direction is more likely to cause interference problems with the jig than the inner shroud 24 that has a smaller protruding amount from the leading edge portion 21 in a direction orthogonal to the vane height direction. Thus, as depicted in FIG. 12 for instance, with the distance V90 between the position K1, which is the boundary between a range where the outer third film cooling holes 731 are formed and a range where the inner third film cooling holes 723 are formed, and the inner shroud 24 in the vane height direction being greater than the distance V91 between the first position K1 and the inner shroud 24 in the vane height direction, it is possible to form each of the outer third film cooling holes 731 and the inner third film cooling holes 732 while suppressing interference between the jig and each of the outer shroud 22 and the inner shroud 24.

Furthermore, when forming each of the first to third film cooling holes 71 to 73 by laser processing or the like using a jig from the outer surface 25 of the airfoil portion 20, the larger shroud 92 that has the greatest protruding amount A3 from the leading edge portion 21 in a direction orthogonal to the vane height direction is more likely to cause interference problems with the jig than the smaller shroud 93. Thus, with the distance V92 between the position K1 and the larger shroud 92 in the vane height direction being greater than the distance V93 between the first position K1 and the smaller shroud 93 in the vane height direction, it is possible to form each of the first to third film cooling holes 71 to 73 while suppressing interference between the jig and each of the outer shroud 22 and the inner shroud 24.

Furthermore, as described with reference to FIGS. 5, 6, 9, and 12, each of the first film cooling holes 71, the second film cooling holes 72, and the third film cooling holes 73 extends along a direction inclined with respect a plane that is orthogonal to the vane height direction. Therefore, compared to a case where each of the first film cooling holes 71, the second film cooling holes 72, and the third film cooling holes 73 extends in the thickness direction of the leading edge portion 21, it is possible to perform film cooling on the outer surface 25 of the leading edge portion 21 with a smaller amount of cooling air effectively, and thus it is possible to suppress deterioration of the film efficiency of film cooling of the vane surface while reducing the amount of cooling air.

Furthermore, as described with reference to FIGS. 7A, 10A, and 13A for instance, the cross-sectional areas of the respective shaped hole portions 75, 79, 83 of the outer first film cooling holes 711, the outer second film cooling holes 721, and the outer third film cooling holes 731 are increased only at the inner side in the vane height direction with respect to the circular hole portions 74, 88, 82, respectively, and thereby it is possible to easily form each of the outer first film cooling holes 711, the outer second film cooling holes 721, and the outer third film cooling holes 731 by laser processing or the like. Furthermore, the cross-sectional areas of the respective shaped hole portions 77, 81, 85 of the inner first film cooling holes 712, the inner second film cooling holes 722, and the inner third film cooling holes 732 are increased only at the outer side in the vane height direction with respect to the circular hole portions 76, 88, 84, respectively, and thereby it is possible to easily form each of the inner first film cooling holes 712, the inner second film cooling holes 722, and the inner third film cooling holes 732 by laser processing or the like.

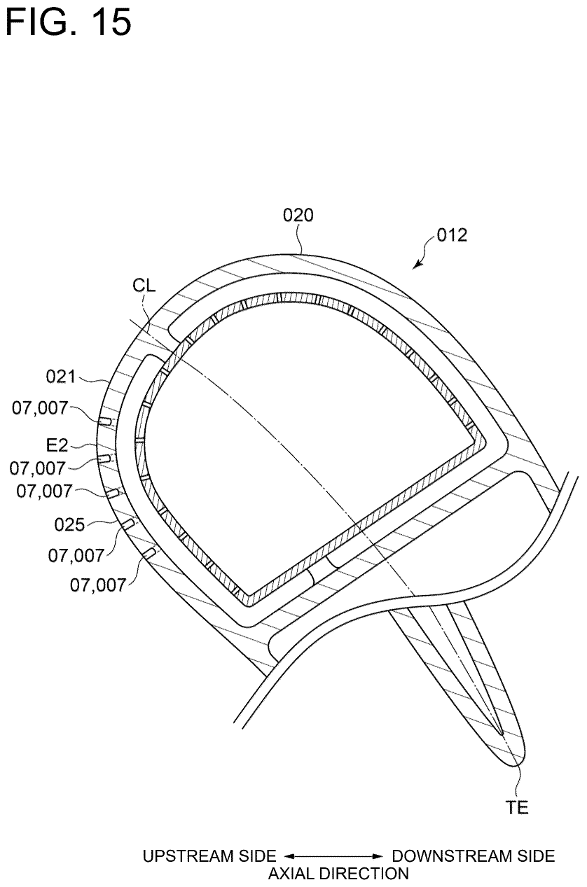

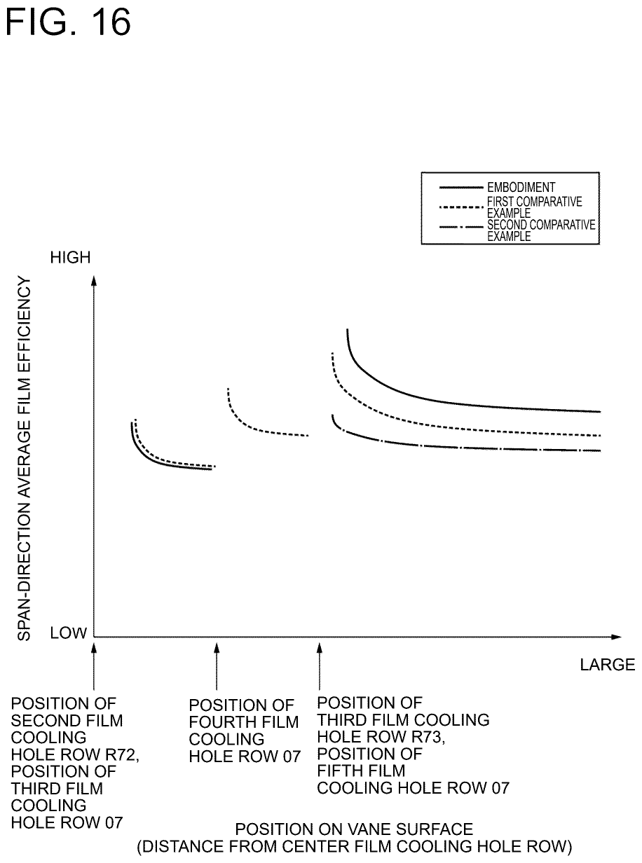

FIG. 15 is a diagram showing a cross section of a turbine stator vane 012 according to a first comparative example, taken along a direction that is orthogonal to the vane height direction. FIG. 16 is a diagram showing the relationship between the distance from the second film cooling hole row R72 of the turbine stator vane 12 according to the above embodiment and the average film efficiency in the vane span direction, and the relationship between the distance from the film cooling hole row 07 that is the third row of the turbine stator vane 012 according to the first comparative example (the film cooling hole row corresponding to the second film cooling hole row R72) and the average film efficiency in the vane span direction.

In the first comparative example depicted in FIG. 15, five film cooling hole rows 07 are formed on the leading edge portion 021 of the turbine stator vane 012, and each of the film cooling hole rows 07 includes a plurality of film cooling holes 007 arranged along the vane height direction. Furthermore, in each of the film cooling hole rows 07, the film cooling hole 007 has a circular cross-sectional shape, and when a vertical plane is defined as a plane including the thickness direction and the vane height direction of the leading edge portion 021 at the center of the inlet of the film cooling hole 007, the outlet of the film cooling hole 007 is positioned at a position where the vertical plane intersects with the outer surface 025 of the leading edge portion 021.

In FIG. 16, the solid line represents the relationship between the distance from the second film cooling hole row R72 of the turbine stator vane 12 according to the above embodiment and the average film efficiency in the vane span direction, and the broken line represents the relationship between the distance from the film cooling hole row 07 that is the third row of the turbine stator vane 012 according to the first comparative example and the average film efficiency in the vane span direction, and the dotted chain line represents the relationship between the distance from the center film cooling hole row 07 of the turbine stator vane 012 according to the second comparative example where the number of film cooling hole rows is reduced by two to three rows compared to the configuration of the first comparative example and the average film efficiency in the vane span direction.

As depicted in FIG. 16, in the second comparative example, the number of film cooling hole rows 07 is reduced from five rows to three rows compared to the first comparative example, and thus the film efficiency is deteriorated. Contrary to this, in the above embodiment, even though the number of film cooling hole rows is reduced from five rows to three rows compared to the first comparative example, the third film cooling hole row R73 includes the above shaped hole portions 83, 85, and thereby the film efficiency is improved at the downstream side of the third film cooling hole row R73 in the flow direction of combustion gas along the leading edge portion 21. As described above, in the above turbine stator vane 12, it is possible to perform film cooling on the outer surface 25 of the leading edge portion 21 with a smaller amount of cooling air effectively, and thus it is possible to suppress deterioration of the film efficiency of film cooling of the vane surface while reducing the amount of cooling air.

The present disclosure is not limited to the embodiments described above, and various amendments and modifications may be implemented.

For instance, in a view as seen in the direction of the axis L74 of the circular hole portion 74, the cross-sectional area of the shaped hole portion 75 may be increased not only at the inner side but also at the outer side with respect to the circular hole portion 74 in the vane height direction, and the cross-sectional area of the shaped hole portion 75 may be increased in a direction orthogonal to the vane height direction. Furthermore, in a view as seen in the direction of the axis L76 of the circular hole portion 76, the cross-sectional area of the shaped hole portion 77 may be increased not only at the outer side but also at the inner side with respect to the circular hole portion 76 in the vane height direction, and the cross-sectional area of the shaped hole portion 85 may be increased in a direction orthogonal to the vane height direction.

Furthermore, in a view as seen in the direction of the axis L78 of the circular hole portion 78, the cross-sectional area of the shaped hole portion 79 may be increased not only at the inner side but also at the outer side with respect to the circular hole portion 78 in the vane height direction and the cross-sectional area of the shaped hole portion 79 may be increased in a direction orthogonal to the vane height direction. Furthermore, in a view as seen in the direction of the axis L80 of the circular hole portion 80, the cross-sectional area of the shaped hole portion 81 may be increased not only at the outer side but also at the inner side with respect to the circular hole portion 80 in the vane height direction, and the cross-sectional area of the shaped hole portion 81 may be increased in a direction orthogonal to the vane height direction.

Furthermore, in a view as seen in the direction of the axis L82 of the circular hole portion 82, the cross-sectional area of the shaped hole portion 83 may be increased not only at the inner side but also at the outer side with respect to the circular hole portion 82 in the vane height direction, and the cross-sectional area of the shaped hole portion 83 may be increased in a direction orthogonal to the vane height direction. Furthermore, in a view seen in the direction of the axis L84 of the circular hole portion 84, the cross-sectional area of the shaped hole portion 85 may be increased not only at the outer side but also at the inner side with respect to the circular hole portion 84 in the vane height direction, and the cross-sectional area of the shaped hole portion 85 may be increased in a direction orthogonal to the vane height direction.

The contents described in the above respective embodiments can be understood as follows, for instance.

(1) According to at least one embodiment of the present disclosure, a gas turbine stator vane (e.g., the above described turbine stator vane 12) includes: an airfoil portion (e.g., the above described airfoil portion 20) having a cavity (e.g., the above described in-vane cavity 42) formed therein. The airfoil portion includes a leading edge portion (e.g., the above described leading edge portion 20) which has: a first film cooling hole row (e.g., the above described first film cooling hole row R71) formed thereon including a plurality of first film cooling holes (e.g., the above described plurality of first film cooling holes 71) arranged along a vane height direction; a second film cooling hole row (e.g., the above described second film cooling hole row R72) formed thereon including a plurality of second film cooling holes (e.g., the above described plurality of second film cooling holes 72) arranged along the vane height direction; and a third film cooling hole row (e.g., the above described third film cooling hole row R73) formed thereon including a plurality of third film cooling holes (e.g., the above described plurality of third film cooling holes 73) arranged along the vane height direction. The second film cooling row is disposed between the first film cooling hole row and the third film cooling hole row. Each of the first film cooling holes extends in a direction inclined with respect to a thickness direction of the leading edge portion, and when defining a first plane (e.g., the above described first plane H1) as a plane including the thickness direction of the leading edge portion and the vane height direction at a center (e.g., the above described center Cla) of an inlet (e.g., the above described inlet 71a) of the first film cooling hole, a center (e.g., the above described center C1b) of an outlet (e.g., the above described outlet 71b) of the first film cooling hole is positioned at a downstream side of a flow of combustion gas (e.g., the above described flow F) along the leading edge portion with respect to a position (e.g., the above described position P1) where the first plane and an outer surface (e.g., the above described outer surface 25) of the leading edge portion intersect. Each of the second film cooling holes extends in a direction inclined with respect to the thickness direction of the leading edge portion, and when defining a second plane (e.g., the above described plane H2) as a plane including the thickness direction of the leading edge portion and the vane height direction at a center (e.g., the above described center C2a) of an inlet (e.g., the above described inlet 72a) of the second film cooling hole, an outlet (e.g., the above described outlet 72b) of the second film cooling hole is positioned at a position (e.g., the above described position P2) where the second plane and the outer surface of the leading edge portion intersect. Each of the third film cooling holes extends in a direction inclined with respect to the thickness direction of the leading edge portion, and when defining a third plane (e.g., the above described third plane H3) as a plane including the thickness direction of the leading edge portion and the vane height direction at a center (e.g., the above described center C3a) of an inlet (e.g., the above described outlet 73a) of the third film cooling hole, a center (e.g., the above described center C3b) of an outlet (e.g., the above described outlet 73b) of the third film cooling hole is positioned at a downstream side of the flow of the combustion gas (e.g., the above described flow F) along the leading edge portion with respect to a position (e.g., the above described position P3) where the third plane and the outer surface of the leading edge portion intersect.

With the gas turbine stator vane according to the above (1), the first film cooling hole row, the second film cooling hole row, and the third film cooling hole row, each of which is arranged along the vane height direction, are formed on the leading edge portion to be exposed to a flow of high temperature combustion gas. Herein, each of the first film cooling holes, the second film cooling holes, and the third film cooling holes extends in a direction inclined with respect to the thickness direction of the leading edge portion, the center of the outlet of the first film cooling hole is positioned at the downstream side of the flow of combustion gas along the leading edge portion with respect to the position where the first plane and the outer surface of the leading edge portion intersect, the outlet of the second film cooling hole is positioned at the position where the second plane and the outer surface of the leading edge portion intersect, and the center of the outlet of the third film cooling hole is positioned at the downstream side of the flow of combustion gas along the leading edge portion with respect to the position where the third plane and the outer surface of the leading edge portion intersect. Thus, by arranging the second film cooling hole row such that the second film cooling holes are positioned at the position of the stagnation point of the flow of combustion gas on the outer surface of the leading edge portion of the airfoil portion or in the vicinity thereof, it is possible to let cooling air for film cooling flow out from the first film cooling holes and the third film cooling holes toward the downstream sides of the flow of combustion gas at both sides of a boundary which is the position of the stagnation point of the flow of combustion gas on the outer surface of the leading edge portion of the airfoil portion. Therefore, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(2) In some embodiments, in the gas turbine stator vane according to the above (1), each of the first film cooling holes, the second film cooing holes, and the third film cooling holes is positioned at a side of a pressure surface (e.g., the above described pressure surface 40) with respect to a camber line (e.g., the above described camber line CL), in a cross section of the airfoil portion orthogonal to the vane height direction.

The stagnation point of the flow of combustion gas on the outer surface of the leading edge portion of the airfoil portion is generated at the side of the pressure surface with respect to the camber line. Thus, with the gas turbine stator vane according to the above (2), by arranging the second film cooling hole row such that the second film cooling holes are positioned at the position of the stagnation point of the flow of combustion gas on the outer surface of the leading edge portion of the airfoil portion or in the vicinity thereof, it is possible to let cooling air for film cooling flow out from the first film cooling holes and the third film cooling holes toward the downstream sides of the flow of combustion gas at both sides of a boundary which is the position of the stagnation point of the flow of combustion gas on the outer surface of the leading edge portion of the airfoil portion. Therefore, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(3) In some embodiments, in the gas turbine stator vane according to the above (1) or (2), in the cross section of the airfoil portion orthogonal to the vane height direction, when E1 is an intersection between the camber line and the outer surface of the leading edge portion and E2 is a most upstream position of the airfoil portion in an axial direction of a gas turbine, the outlet of the first film cooling hole is positioned between the intersection E1 and the most upstream position E2 on an outer surface of the airfoil portion, and the outlet of the third film cooling hole is positioned opposite to the intersection E1 across the most upstream position E2 on the outer surface of the airfoil portion.

With the gas turbine stator vane according to the above (3), it is possible to let cooling air for film cooling flow out toward the downstream side of the flow of combustion gas from the first film cooling holes and the third film cooling holes at both sides across the most upstream position E2, and thus it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(4) In some embodiments, in the gas turbine stator vane according to the above (3), in the cross section of the airfoil portion orthogonal to the vane height direction, the outlet of the second film cooling hole is positioned opposite to the intersection E1 across the most upstream position E2 on the outer surface of the airfoil portion.

With the gas turbine stator vane according to the above (4), it is possible to provide a gas turbine stator vane capable of suppressing deterioration of the film efficiency of film cooling of the vane surface while reducing the amount of cooling air.

(5) In some embodiments, in the gas turbine stator vane according to any one of the above (1) to (4), the airfoil portion includes: a pressure surface formation wall (e.g., the above described pressure surface formation wall 44) forming a pressure surface (e.g., the above described pressure surface 40); a suction surface formation wall (e.g., the above described suction surface formation wall 38) forming a suction surface (e.g., the above described suction surface 36); and a leading edge portion partition wall (e.g., the above described leading edge portion partition wall 48) extending from an inner surface of the suction surface formation wall to an inner surface of the pressure surface formation wall so as to divide the cavity inside the airfoil portion. In a cross section of the airfoil portion orthogonal to the vane height direction, each of the first film cooling holes, the second film cooling holes, and the third film cooling holes is positioned at an upstream side of a position (e.g., the above described position G) where the pressure surface formation wall and the leading edge portion partition wall connect in an axial direction of a gas turbine.

The stagnation point of the flow of combustion gas on the outer surface of the leading edge portion of the airfoil portion is generated at the upstream side of a position where the pressure surface formation wall and the leading edge portion partition wall connect. Thus, with the gas turbine stator vane according to the above (5), by arranging the second film cooling hole row such that the second film cooling holes are disposed at the position of the stagnation point of the flow of combustion gas on the outer surface of the leading edge portion of the airfoil portion or in the vicinity thereof, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(6) In some embodiments, in the gas turbine stator vane according to any one of the above (1) to (5), each of the first film cooling holes, the second film cooling holes, and the third film cooling holes extends along a direction inclined with respect to a plane orthogonal to the vane height direction.

With the gas turbine stator vane according to the above (6), compared to a case where each of the first film cooling holes, the second film cooling holes, and the third film cooling holes extends in the thickness direction of the leading edge portion, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(7) In some embodiments, in the gas turbine stator vane according to any one of the above (1) to (6), the plurality of third film cooling holes include a plurality of outer third film cooling holes (e.g., the above described plurality of outer third film cooling holes 731) positioned at an outer side of a first position (e.g., the above described first position K1) in the vane height direction and a plurality of inner third film cooling holes (e.g., the above described plurality of inner third film cooling holes 732) positioned at an inner side of the first position in the vane height direction. Each of the outer third film cooling holes extends inward in the vane height direction from an inlet (e.g., the above described inlet 73a) toward an outlet (e.g., the above described outlet 73b) of the outer third film cooling hole. Each of the inner third film cooling holes extends outward in the vane height direction from an inlet (e.g., the above described inlet 73a) toward an outlet (e.g., the above described outlet 73b) of the inner third film cooling hole.

With the gas turbine stator vane according to the above (7), compared to a case where each of the outer third film cooling holes and the inner third film cooling holes extends in the thickness direction of the leading edge portion, it is possible to perform film cooling on the outer surface of the leading edge portion with a smaller amount of cooling air effectively. Furthermore, the outer third film cooling hole extends inward in the vane height direction from the inlet toward the outlet of the outer third film cooling hole, and thus compared to a case where the outer third film cooling hole extends outward in the vane height direction from the inlet toward the outlet of the outer third film cooling hole, it is possible to suppress interference between a jig and each of the outer shroud and the inner shroud in a case where a jig is used to form the outer third film cooling hole by laser processing or the like from the side of the outer surface of the airfoil portion. Furthermore, the inner third film cooling hole extends outward in the vane height direction from the inlet toward the outlet of the inner third film cooling hole, and thus compared to a case where the inner third film cooling hole extends inward in the vane height direction from the inlet toward the outlet of the inner third film cooling hole, it is possible to suppress interference between a jig and each of the outer shroud and the inner shroud in a case where a jig is used to form the inner third film cooling hole by laser processing or the like from the side of the outer surface of the airfoil portion.

(8) In some embodiments, the gas turbine stator vane according to the above (7) includes an outer shroud (e.g., the above described outer shroud 22) connecting to an outer end of the airfoil portion in the vane height direction; and an inner shroud (e.g., the above described inner shroud 24) connecting to an inner end of the airfoil portion in the vane height direction. In a cross section (e.g., the cross section depicted in FIG. 12) including an axis of the third film cooling hole and the vane height direction, when defining a larger shroud (e.g., the above described larger shroud 90) as one of the outer shroud or the inner shroud which has a larger protruding amount from the leading edge portion in a direction orthogonal to the vane height direction and a smaller shroud (e.g., the above described smaller shroud 91) as one of the outer shroud or the inner shroud which is not the larger shroud, a distance (e.g., the above described distance V90) between the first position and the larger shroud in the vane height direction is greater than a distance (e.g., the above described distance V91) between the first position and the smaller shroud in the vane height direction.

When forming each of the outer third film cooling holes and the inner third film cooling holes by laser processing or the like using a jig from the outer surface side of the airfoil portion, the larger shroud that has a greater protruding amount from the leading edge portion in a direction orthogonal to the vane height direction is more likely to cause interference problems with the jig than the smaller shroud. Thus, as described in the above (8), with the distance between the first position and the larger shroud in the vane height direction being greater than the distance between the first position and the smaller shroud in the vane height direction, it is possible to form each of the outer third film cooling holes and the inner third film cooling holes while suppressing interference between the jig and each of the outer shroud and the inner shroud.

(9) In some embodiments, in the gas turbine stator vane according to the above (7) or (8), the plurality of first film cooling holes include a plurality of outer first film cooling holes (e.g., the above described plurality of outer first film cooling holes 711) positioned at the outer side of the first position in the vane height direction and a plurality of inner first film cooling holes (e.g., the above described plurality of inner first film cooling holes 712) positioned at the inner side of the first position in the vane height direction. Each of the outer first film cooling holes extends inward in the vane height direction from an inlet (e.g., the above described inlet 71a) toward an outlet (e.g., the above described outlet 71b) of the outer first film cooling hole. Each of the inner first film cooling holes extends outward in the vane height direction from an inlet (e.g., the above described inlet 71a) toward an outlet (e.g., the above described outlet 71b) of the inner first film cooling hole. The plurality of second film cooling holes include a plurality of outer second film cooling holes (e.g., the plurality of outer second film cooling holes 721) positioned at the outer side of the first position in the vane height direction and a plurality of inner second film cooling holes (e.g., the plurality of inner second film cooling holes 722) positioned at the inner side of the first position in the vane height direction. Each of the outer second first film cooling holes extends inward in the vane height direction from an inlet (e.g., the above described inlet 72a) toward an outlet (e.g., the above described outlet 72b) of the outer second film cooling hole. Each of the inner second film cooling holes extends outward in the vane height direction from an inlet (e.g., the above described inlet 72a) toward an outlet (e.g., the above described outlet 72b) of the inner second film cooling hole.

With the gas turbine stator vane according to the above (9), compared to a case where each of the outer first film cooling holes and the inner first film cooling holes extends in the thickness direction of the leading edge portion, it is possible to perform film cooling on the outer surface of the leading edge portion with a smaller amount of cooling air effectively. Furthermore, the outer first film cooling hole extends inward in the vane height direction from the inlet toward the outlet of the outer first film cooling hole, and thus compared to a case where the outer first film cooling hole extends outward in the vane height direction from the inlet toward the outlet of the outer first film cooling hole, it is possible to suppress interference between a jig and each of the outer shroud and the inner shroud in a case where a jig is used to form the outer first film cooling hole by laser processing or the like from the side of the outer surface of the airfoil portion. Furthermore, the inner first film cooling hole extends outward in the vane height direction from the inlet toward the outlet of the inner first film cooling hole, and thus compared to a case where the inner first film cooling hole extends inward in the vane height direction from the inlet toward the outlet of the inner first film cooling hole, it is possible to suppress interference between a jig and each of the outer shroud and the inner shroud in a case where a jig is used to form the inner first film cooling hole by laser processing or the like from the side of the outer surface of the airfoil portion. Furthermore, compared to a case where each of the outer second film cooling holes and the inner second film cooling holes extends in the thickness direction of the leading edge portion, it is possible to perform film cooling on the outer surface of the leading edge portion with a smaller amount of cooling air effectively. Furthermore, the outer second film cooling hole extends inward in the vane height direction from the inlet toward the outlet of the outer second film cooling hole, and thus compared to a case where the outer second film cooling hole extends outward in the vane height direction from the inlet toward the outlet of the outer second film cooling hole, it is possible to suppress interference between a jig and each of the outer shroud and the inner shroud in a case where a jig is used to form the outer second film cooling hole by laser processing or the like from the side of the outer surface of the airfoil portion. Furthermore, the inner second film cooling hole extends outward in the vane height direction from the inlet toward the outlet of the inner second film cooling hole, and thus compared to a case where the inner second film cooling hole extends inward in the vane height direction from the inlet toward the outlet of the inner second film cooling hole, it is possible to suppress interference between a jig and each of the outer shroud and the inner shroud in a case where a jig is used to form the inner second film cooling hole from the side of the outer surface of the airfoil portion.

(10) In some embodiments, the gas turbine stator vane according to the above (9) includes an outer shroud (e.g., the above described outer shroud 22) connecting to an outer end of the airfoil portion in the vane height direction; and an inner shroud (e.g., the above described inner shroud 24) connecting to an inner end of the airfoil portion in the vane height direction. When, in a cross section (e.g., the cross section depicted in FIG. 6) including an axis of the first film cooling hole and the vane height direction, A1 is a protruding amount of the outer shroud from the leading edge portion in a direction orthogonal to the vane height direction and B1 is a protruding amount of the inner shroud from the leading edge portion in the direction orthogonal to the vane height direction, in a cross section (e.g., the cross section depicted in FIG. 9) including an axis of the second film cooling hole and the vane height direction, A2 is a protruding amount of the outer shroud from the leading edge portion in the direction orthogonal to the vane height direction and B2 is a protruding amount of the inner shroud from the leading edge portion in the direction orthogonal to the vane height direction, and in a cross section (e.g., the cross section depicted in FIG. 12) including an axis of the third film cooling hole and the vane height direction, A3 is a protruding amount of the outer shroud from the leading edge portion in the direction orthogonal to the vane height direction and B3 is a protruding amount of the inner shroud from the leading edge portion in the direction orthogonal to the vane height direction, defining a larger shroud (e.g., the above described larger shroud 90) as one of the outer shroud or the inner shroud which has the largest protruding amount among the protruding amounts A1, A2, A3, B1, B2, and B3 and a smaller shroud (e.g., the above described smaller shroud 91) as one of the outer shroud or the inner shroud which is not the larger shroud, a distance (e.g., the above described distance V90) between the first position and the larger shroud in the vane height direction is greater than a distance (e.g., the above described distance V91) between the first position and the smaller shroud in the vane height direction.

In a case where each of the first to third film cooling holes is formed by laser processing or the like using a jig from the outer surface side of the airfoil portion, the larger shroud that has the greatest protruding amount from the leading edge portion in a direction orthogonal to the vane height direction is more likely to cause interference problems with the jig than the smaller shroud. Thus, as described in the above (10), with the distance between the first position and the larger shroud in the vane height direction being greater than the distance between the first position and the smaller shroud in the vane height direction, it is possible to form each of the first to third film cooling holes while suppressing interference between the jig and each of the outer shroud and the inner shroud.

(11) In some embodiments, in the gas turbine stator vane according to any one of the above (7) to (10), the outer third film cooling hole includes: a circular hole portion (e.g., the above described circular hole portion 82) disposed at a side of the inlet of the outer third film cooling hole, the circular hole portion having a circular cross-sectional shape; and a shaped hole portion (e.g., the above described shaped hole portion 83) disposed at a side of the outlet of the outer third film cooling hole, the shaped hole portion connecting to the circular hole portion and having a cross-sectional area which increases toward the outlet of the outer third film cooling hole. The inner third film cooling hole includes: a circular hole portion (e.g., the above described circular hole portion 84) disposed at a side of the inlet of the inner third film cooling hole, the circular hole portion having a circular cross-sectional shape; and a shaped hole portion (e.g., the above described shaped hole portion 85) disposed at a side of the outlet of the inner third film cooling hole, the shaped hole portion connecting to the circular hole portion and having a cross-sectional area which increases toward the outlet of the inner third film cooling hole. A center (e.g., the center C3b in FIG. 13A) of the outlet of the outer third film cooling hole is positioned at an inner side, in the vane height direction, of an intersection (e.g., the above described intersection S31) between an extension line of an axis (e.g., the above described axis L82) of the circular hole portion of the outer third film cooling hole and the outlet of the outer third film cooling hole. A center (e.g., the center C3b in FIG. 13B) of the outlet of the inner third film cooling hole is positioned at an outer side, in the vane height direction, of an intersection (e.g., the above described intersection S32) between an extension line of an axis (e.g., the above described axis L84) of the circular hole portion of the inner third film cooling hole and the outlet of the inner third film cooling hole.

With the gas turbine stator vane according to the above (11), compared to a case where the center of the outlet of the outer third film cooling hole and the center of the outlet of the inner third film cooling hole are positioned on the extension line of the axis of the circular hole portion of the outer third film cooling hole and the extension line of the axis of the circular hole portion of the inner third film cooling hole respectively, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(12) In some embodiments, in the gas turbine stator vane according to any one of the above (9) to (11), the outer first film cooling hole includes: a circular hole portion (e.g., the above described circular hole portion 74) disposed at a side of the inlet of the outer first film cooling hole, the circular hole portion having a circular cross-sectional shape; and a shaped hole portion (e.g., the above described shaped hole portion 75) disposed at a side of the outlet of the outer first film cooling hole, the shaped hole portion connecting to the circular hole portion and having a cross-sectional area which increases toward the outlet of the outer first film cooling hole. The inner first film cooling hole includes: a circular hole portion (e.g., the above described circular hole portion 76) disposed at a side of the inlet of the inner first film cooling hole, the circular hole portion having a circular cross-sectional shape; and a shaped hole portion (e.g., the above described shaped hole portion 77) disposed at a side of the outlet of the inner first film cooling hole, the shaped hole portion connecting to the circular hole portion of the inner first film cooling hole and having a cross-sectional area which increases toward the outlet of the inner first film cooling hole. A center (e.g., the center C1b in FIG. 7A) of the outlet of the outer first film cooling hole is positioned at an inner side, in the vane height direction, of an intersection (e.g., the above described intersection S11) between an extension line of an axis (e.g., the above described axis L74) of the circular hole portion of the outer first film cooling hole and the outlet of the outer first film cooling hole. A center (e.g., the center C1b in FIG. 7B) of the outlet of the inner first film cooling hole is positioned at an outer side, in the vane height direction, of an intersection (e.g., the above described intersection S12) between an extension line of an axis (e.g., the above described axis L76) of the circular hole portion of the inner first film cooling hole and the outlet of the inner first film cooling hole. The outer second film cooling hole includes: a circular hole portion (e.g., the above described circular hole portion 78) disposed at a side of the inlet of the outer second film cooling hole, the circular hole portion having a circular cross-sectional shape; and a shaped hole portion (e.g., the above described shaped hole portion 79) disposed at a side of the outlet of the outer second film cooling hole, the shaped hole portion connecting to the circular hole portion of the outer film cooling hole and having a cross-sectional area which increases toward the outlet of the outer second film cooling hole. The inner second film cooling hole includes: a circular hole portion (e.g., the above described circular hole portion 80) disposed at a side of the inlet of the inner second film cooling hole, the circular hole portion having a circular cross-sectional shape; and a shaped hole portion (e.g., the above described circular hole portion 81) disposed at a side of the outlet of the inner second film cooling hole, the shaped hole portion connecting to the circular hole portion of the inner second film cooling hole and having a cross-sectional area which increases toward the outlet of the inner second film cooling hole. A center (e.g., the center C2b in FIG. 10A) of the outlet of the outer second film cooling hole is positioned at an inner side, in the vane height direction, of an intersection (e.g., the above described intersection S21) between an extension line of an axis (e.g., the above described axis L78) of the circular hole portion of the outer second film cooling hole and the outlet of the outer second film cooling hole. A center (e.g., the center C2b in FIG. 10B) of the outlet of the inner second film cooling hole is positioned at an outer side, in the vane height direction, of an intersection (e.g., the above described intersection S22) between an extension line of an axis (e.g., the above described axis L80) of the circular hole portion of the inner second film cooling hole and the outlet of the inner second film cooling hole.

With the gas turbine stator vane according to the above (12), compared to a case where the center of the outlet of the outer first film cooling hole and the center of the outlet of the inner first film cooling hole are positioned on the extension line of the axis of the circular hole portion of the outer first film cooling hole and the extension line of the axis of the circular hole portion of the inner first film cooling hole respectively, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air. Furthermore, compared to a case where the center of the outlet of the outer second film cooling hole and the center of the outlet of the inner second film cooling hole are positioned on the extension line of the axis of the circular hole portion of the outer second film cooling hole and the extension line of the axis of the circular hole portion of the inner second film cooling hole respectively, it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

(13) In some embodiments, in the gas turbine stator vane according to the above (12), the shaped hole portion of the outer first film cooling hole has a cross-sectional area which is increased only at an inner side in the vane height direction with respect to the circular hole portion of the outer first film cooling hole in a view seen in a direction of an axis of the circular hole portion of the outer first film cooling hole. The shaped hole portion of the inner first film cooling hole has a cross-sectional area which is increased only at an outer side in the vane height direction with respect to the circular hole portion of the inner first film cooling hole in a view seen in a direction of an axis of the circular hole portion of the inner first film cooling hole. The shaped hole portion of the outer second film cooling hole has a cross-sectional area which is increased only at an inner side in the vane height direction with respect to the circular hole portion of the outer second film cooling hole in a view seen in a direction of an axis of the circular hole portion of the outer second film cooling hole. The shaped hole portion of the inner second film cooling hole has a cross-sectional area which is increased only at an outer side in the vane height direction with respect to the circular hole portion of the inner second film cooling hole in a view seen in a direction of an axis of the circular hole portion of the inner second film cooling hole. The shaped hole portion of the outer third film cooling hole has a cross-sectional area which is increased only at an inner side in the vane height direction with respect to the circular hole portion of the outer third film cooling hole in a view seen in a direction of an axis of the circular hole portion of the outer third film cooling hole. The shaped hole portion of the inner third film cooling hole has a cross-sectional area which is increased only at an outer side in the vane height direction with respect to the circular hole portion of the inner third film cooling hole in a view seen in a direction of an axis of the circular hole portion of the inner third film cooling hole.

With the gas turbine stator vane according to the above (13), the cross-sectional areas of the respective shaped hole portions of the outer first film cooling holes, the outer second film cooling holes, and the outer third film cooling holes are increased only at the inner side in the vane height direction with respect to the circular hole portions, and thereby it is possible to easily form each of the outer first film cooling holes, the outer second film cooling holes, and the outer third film cooling holes by laser processing or the like. Furthermore, the cross-sectional areas of the respective shaped hole portions of the inner first film cooling holes, the inner second film cooling holes, and the inner third film cooling holes are increased only at the outer side in the vane height direction with respect to the circular hole portions, and thereby it is possible to easily form each of the inner first film cooling holes, the inner second film cooling holes, and the inner third film cooling holes by laser processing or the like. Thus, it is possible to facilitate production of gas turbine stator vanes.

(14) According to at least one embodiment of the present disclosure (14), a gas turbine includes: a compressor (e.g., the above described compressor 4); a combustor (e.g., the above described combustor 6); and a turbine (e.g., the above described turbine 8). The turbine includes the gas turbine stator vane according to any one of the above (1) to (13).

With the above gas turbine according to the above (14), the gas turbine includes the gas turbine stator vane according to any one of the above (1) to (13), and thus it is possible to provide a gas turbine stator vane capable of performing film cooling on the outer surface of the leading edge portion with a smaller amount of cooling air effectively, and suppressing deterioration of the film efficiency of film cooling of the vane surface while reducing the amount of cooling air.

### REFERENCE SIGNS LIST

2 Gas turbine
4 Compressor
6 Combustor
8 Turbine
9 Rotor
10 Turbine casing
12 Turbine stator vane
16 Turbine rotor blade
20 Airfoil portion
20a Outer end
20b Inner end
21 Leading edge portion
22 Outer shroud
24 Inner shroud
25 Outer surface
26, 39,45 Inner surface
31 Flow passage
32 Outer cavity
33 Outer circumferential wall
34 Inner cavity
35 Inner circumferential wall
36 Suction surface
38 Suction surface formation wall
40 Pressure surface
42 In-vane cavity
44 Pressure surface formation wall
46 Leading edge side cavity
48 Leading edge portion partition wall
49 Trailing edge side cavity
50 Insert
51 Internal space
52 Impingement cooling hole
71 First film cooling hole
711 Outer first film cooling hole
712 Inner first film cooling hole
72 Second film cooling hole
721 Outer second film cooling hole
722 Inner second film cooling hole
71a, 72a, 73a Inlet
71b, 72b, 73b Outlet
73 Third film cooling hole
731 Outer third film cooling hole
732 Inner first film cooling hole
74, 76, 78, 80, 82, 84 Circular hole portion
75, 77, 79, 81, 83, 85 Shaped hole portion
90, 92 Larger shroud
91, 93 Smaller shroud

1-14. (canceled)

15. A gas turbine stator vane, comprising:
an airfoil portion having a cavity formed therein,
wherein the airfoil portion includes a leading edge portion which has:
a first film cooling hole row formed thereon including a plurality of first film cooling holes arranged along a vane height direction;
a second film cooling hole row formed thereon including a plurality of second film cooling holes arranged along the vane height direction; and
a third film cooling hole row formed thereon including a plurality of third film cooling holes arranged along the vane height direction,
wherein the second film cooling row is disposed between the first film cooling hole row and the third film cooling hole row,
wherein each of the first film cooling holes extends in a direction inclined with respect to a thickness direction of the leading edge portion, and when defining a first plane as a plane including the thickness direction of the leading edge portion and the vane height direction at a center of an inlet of the first film cooling hole, a center of an outlet of the first film cooling hole is positioned at a downstream side of a flow of combustion gas along the leading edge portion with respect to a position where the first plane and an outer surface of the leading edge portion intersect,
wherein each of the second film cooling holes extends in a direction inclined with respect to the thickness direction of the leading edge portion, and when defining a second plane as a plane including the thickness direction of the leading edge portion and the vane height direction at a center of an inlet of the second film cooling hole, an outlet of the second film cooling hole is positioned at a position where the second plane and the outer surface of the leading edge portion intersect,
wherein each of the third film cooling holes extends in a direction inclined with respect to the thickness direction of the leading edge portion, and when defining a third plane as a plane including the thickness direction of the leading edge portion and the vane height direction at a center of an inlet of the third film cooling hole, a center of an outlet of the third film cooling hole is positioned at a downstream side of the flow of the combustion gas along the leading edge portion with respect to a position where the third plane and the outer surface of the leading edge portion intersect,
wherein the plurality of third film cooling holes includes a plurality of outer third film cooling holes positioned at an outer side of a first position in the vane height direction and a plurality of inner third film cooling holes positioned at an inner side of the first position in the vane height direction,
wherein each of the outer third film cooling holes extends inward in the vane height direction from an inlet toward an outlet of the outer third film cooling hole, and
wherein each of the inner third film cooling holes extends outward in the vane height direction from an inlet toward an outlet of the inner third film cooling hole.

16. The gas turbine stator vane according to claim 15,
wherein each of the first film cooling holes, the second film cooing holes, and the third film cooling holes is positioned at a side of a pressure surface with respect to a camber line, in a cross section of the airfoil portion orthogonal to the vane height direction.

17. The gas turbine stator vane according to claim 16,
wherein, in the cross section of the airfoil portion orthogonal to the vane height direction, when E1 is an intersection between the camber line and the outer surface of the leading edge portion and E2 is a most upstream position of the airfoil portion in an axial direction of a gas turbine, the outlet of the first film cooling hole is positioned between the intersection E1 and the most upstream position E2 on an outer surface of the airfoil portion, and the outlet of the third film cooling hole is positioned opposite to the intersection E1 across the most upstream position E2 on the outer surface of the airfoil portion.

18. The gas turbine stator vane according to claim 17,
wherein, in the cross section of the airfoil portion orthogonal to the vane height direction, the outlet of the second film cooling hole is positioned opposite to the intersection E1 across the most upstream position E2 on the outer surface of the airfoil portion.

19. The gas turbine stator vane according to claim 15,
wherein the airfoil portion includes:
a pressure surface formation wall forming a pressure surface;
a suction surface formation wall forming a suction surface; and
a leading edge portion partition wall extending from an inner surface of the suction surface formation wall to an inner surface of the pressure surface formation wall so as to divide the cavity inside the airfoil portion, and
wherein, in a cross section of the airfoil portion orthogonal to the vane height direction, each of the first film cooling holes, the second film cooling holes, and the third film cooling holes is positioned at an upstream side of a position where the pressure surface formation wall and the leading edge portion partition wall connect in an axial direction of a gas turbine.

20. The gas turbine stator vane according to claim 15,
wherein each of the first film cooling holes, the second film cooling holes, and the third film cooling holes extends along a direction inclined with respect to a plane orthogonal to the vane height direction.

21. The gas turbine stator vane according to claim 15, further comprising:
an outer shroud connecting to an outer end of the airfoil portion in the vane height direction; and
an inner shroud connecting to an inner end of the airfoil portion in the vane height direction,
wherein, in a cross section including an axis of the third film cooling hole and the vane height direction, when defining a larger shroud as one of the outer shroud or the inner shroud which has a larger protruding amount from a portion of the leading edge portion where the third film cooling hole row is formed in a direction orthogonal to the vane height direction and a smaller shroud as one of the outer shroud or the inner shroud which is not the larger shroud, a distance between the first position and the larger shroud in the vane height direction is greater than a distance between the first position and the smaller shroud in the vane height direction.

22. The gas turbine stator vane according to claim 15,
wherein the plurality of first film cooling holes include a plurality of outer first film cooling holes positioned at the outer side of the first position in the vane height direction and a plurality of inner first film cooling holes positioned at the inner side of the first position in the vane height direction,
wherein each of the outer first film cooling holes extends inward in the vane height direction from an inlet toward an outlet of the outer first film cooling hole,
wherein each of the inner first film cooling holes extends outward in the vane height direction from an inlet toward an outlet of the inner first film cooling hole,
wherein the plurality of second film cooling holes include a plurality of outer second film cooling holes positioned at the outer side of the first position in the vane height direction and a plurality of inner second film cooling holes positioned at the inner side of the first position in the vane height direction,
wherein each of the outer second first film cooling holes extends inward in the vane height direction from an inlet toward an outlet of the outer second film cooling hole, and
wherein each of the inner second film cooling holes extends outward in the vane height direction from an inlet toward an outlet of the inner second film cooling hole.

23. The gas turbine stator vane according to claim 21, further comprising:
an outer shroud connecting to an outer end of the airfoil portion in the vane height direction; and
an inner shroud connecting to an inner end of the airfoil portion in the vane height direction,
wherein, when,
in a cross section including an axis of the first film cooling hole and the vane height direction, A1 is a protruding amount of the outer shroud from a portion of the airfoil portion where the first film cooling hole row is formed in a direction orthogonal to the vane height direction and B1 is a protruding amount of the inner shroud from the portion of the airfoil portion where the first film cooing hole row is formed in the direction orthogonal to the vane height direction,
in a cross section including an axis of the second film cooling hole and the vane height direction, A2 is a protruding amount of the outer shroud from a portion of the airfoil portion where the second film cooling hole row is formed in the direction orthogonal to the vane height direction and B2 is a protruding amount of the inner shroud from the portion of the airfoil portion where the second film cooing hole row is formed in the direction orthogonal to the vane height direction, and
in a cross section including an axis of the third film cooling hole and the vane height direction, A3 is a protruding amount of the outer shroud from a portion of the airfoil portion where the third film cooling hole row is formed in the direction orthogonal to the vane height direction and B3 is a protruding amount of the inner shroud from the portion of the airfoil portion where the third film cooing hole row is formed in the direction orthogonal to the vane height direction,
defining a larger shroud as one of the outer shroud or the inner shroud which has the largest protruding amount among the protruding amounts A1, A2, A3, B1, B2, and B3 and a smaller shroud as one of the outer shroud or the inner shroud which is not the larger shroud, a distance between the first position and the larger shroud in the vane height direction is greater than a distance between the first position and the smaller shroud in the vane height direction.

24. The gas turbine stator vane according to claim 15,
wherein the outer third film cooling hole includes:
a circular hole portion disposed at a side of the inlet of the outer third film cooling hole, the circular hole portion having a circular cross-sectional shape; and
a shaped hole portion disposed at a side of the outlet of the outer third film cooling hole, the shaped hole portion connecting to the circular hole portion and having a cross-sectional area which increases toward the outlet of the outer third film cooling hole,
wherein the inner third film cooling hole includes:
a circular hole portion disposed at a side of the inlet of the inner third film cooling hole, the circular hole portion having a circular cross-sectional shape; and
a shaped hole portion disposed at a side of the outlet of the inner third film cooling hole, the shaped hole portion connecting to the circular hole portion and having a cross-sectional area which increases toward the outlet of the inner third film cooling hole,
wherein a center of the outlet of the outer third film cooling hole is positioned at an inner side, in the vane height direction, of an intersection between an extension line of an axis of the circular hole portion of the outer third film cooling hole and the outlet of the outer third film cooling hole, and
wherein a center of the outlet of the inner third film cooling hole is positioned at an outer side, in the vane height direction, of an intersection between an extension line of an axis of the circular hole portion of the inner third film cooling hole and the outlet of the inner third film cooling hole.

25. The gas turbine stator vane according to claim 21,
wherein the outer first film cooling hole includes:
a circular hole portion disposed at a side of the inlet of the outer first film cooling hole, the circular hole portion having a circular cross-sectional shape; and
a shaped hole portion disposed at a side of the outlet of the outer first film cooling hole, the shaped hole portion connecting to the circular hole portion and having a cross-sectional area which increases toward the outlet of the outer first film cooling hole,
wherein the inner first film cooling hole includes:
a circular hole portion disposed at a side of the inlet of the inner first film cooling hole, the circular hole portion having a circular cross-sectional shape; and
a shaped hole portion disposed at a side of the outlet of the inner first film cooling hole, the shaped hole portion connecting to the circular hole portion of the inner first film cooling hole and having a cross-sectional area which increases toward the outlet of the inner first film cooling hole,
wherein a center of the outlet of the outer first film cooling hole is positioned at an inner side, in the vane height direction, of an intersection between an extension line of an axis of the circular hole portion of the outer first film cooling hole and the outlet of the outer first film cooling hole,
wherein a center of the outlet of the inner first film cooling hole is positioned at an outer side, in the vane height direction, of an intersection between an extension line of an axis of the circular hole portion of the inner first film cooling hole and the outlet of the inner first film cooling hole,
wherein the outer second film cooling hole includes:
a circular hole portion disposed at a side of the inlet of the outer second film cooling hole, the circular hole portion having a circular cross-sectional shape; and
a shaped hole portion disposed at a side of the outlet of the outer second film cooling hole, the shaped hole portion connecting to the circular hole portion of the outer second film cooling hole and having a cross-sectional area which increases toward the outlet of the outer second film cooling hole,
wherein the inner second film cooling hole includes:
a circular hole portion disposed at a side of the inlet of the inner second film cooling hole, the circular hole portion having a circular cross-sectional shape; and
a shaped hole portion disposed at a side of the outlet of the inner second film cooling hole, the shaped hole portion connecting to the circular hole portion of the inner second film cooling hole and having a cross-sectional area which increases toward the outlet of the inner first film cooling hole,
wherein a center of the outlet of the outer second film cooling hole is positioned at an inner side, in the vane height direction, of an intersection between an extension line of an axis of the circular hole portion of the outer second film cooling hole and the outlet of the outer second film cooling hole, and
wherein a center of the outlet of the inner second film cooling hole is positioned at an outer side, in the vane height direction, of an intersection between an extension line of an axis of the circular hole portion of the inner second film cooling hole and the outlet of the inner second film cooling hole.

26. The gas turbine stator vane according to claim 24,
wherein the shaped hole portion of the outer first film cooling hole has a cross-sectional area which is increased only at an inner side in the vane height direction with respect to the circular hole portion of the outer first film cooling hole in a view seen in an axial direction of the circular hole portion of the outer first film cooling hole,
wherein the shaped hole portion of the inner first film cooling hole has a cross-sectional area which is increased only at an outer side in the vane height direction with respect to the circular hole portion of the inner first film cooling hole in a view seen in an axial direction of the circular hole portion of the inner first film cooling hole,
wherein the shaped hole portion of the outer second film cooling hole has a cross-sectional area which is increased only at an inner side in the vane height direction with respect to the circular hole portion of the outer second film cooling hole in a view seen in an axial direction of the circular hole portion of the outer second film cooling hole,
wherein the shaped hole portion of the inner second film cooling hole has a cross-sectional area which is increased only at an outer side in the vane height direction with respect to the circular hole portion of the inner second film cooling hole in a view seen in an axial direction of the circular hole portion of the inner second film cooling hole,
wherein the shaped hole portion of the outer third film cooling hole has a cross-sectional area which is increased only at an inner side in the vane height direction with respect to the circular hole portion of the outer third film cooling hole in a view seen in an axial direction of the circular hole portion of the outer third film cooling hole, and
wherein the shaped hole portion of the inner third film cooling hole has a cross-sectional area which is increased only at an outer side in the vane height direction with respect to the circular hole portion of the inner third film cooling hole in a view seen in an axial direction of the circular hole portion of the inner third film cooling hole.

27. A gas turbine, comprising:
a compressor;
a combustor; and
a turbine,
wherein the turbine includes the gas turbine stator vane according to claim 15.
